(19) United States
(12) Patent Application Publication
(10) Pub. No.: US 2025/0050601 A1
(43) Pub. Date: Feb. 13, 2025

(54) OPTICAL SYSTEM

(71) Applicant: FUJIFILM Corporation, Tokyo (JP)

(72) Inventors: Haruhiko MIYAMOTO, Saitama-shi (JP); Hiroki SAITO, Saitama-shi (JP); Nobuyuki IWAZAKI, Saitama-shi (JP)

(73) Assignee: FUJIFILM Corporation, Tokyo (JP)

(21) Appl. No.: 18/926,426

(22) Filed: Oct. 25, 2024

Related U.S. Application Data
(63) Continuation of application No. PCT/JP2023/013694, filed on Mar. 31, 2023.

(30) Foreign Application Priority Data
May 31, 2022 (JP) 2022-089189

(51) Int. Cl. B29D 11/00; G02B 1/04; G02B 13/18

(52) U.S. Cl. CPC B29D 11/00403; B29D 11/00442; G02B 1/041; G02B 13/18

(57) ABSTRACT

An optical system includes a compound lens that includes a first lens and a second lens. The first lens is made of a resin, and the second lens is made of glass. In a case where a maximum value of a thickness of the first lens is denoted by A [mm] and a minimum value of the thickness of the first lens is denoted by B [mm], the optical system satisfies Conditional Expressions (1) and (2).

$$A / B \leq 10 \qquad ( 1 )$$

$$A \leq 3 mm \qquad ( 2 )$$

In a case where an amount of plastic deformation of the resin in a state where an indenter is pressed into the resin at a loading rate of 200 mN/10 sec at an environmental temperature of 25° C. is denoted by x [μm], the resin satisfies Conditional Expression (3).

$$1. μm \leq x \leq 4. μm \qquad ( 3 )$$

This application is a continuation application of International Application No. PCT/JP2023/013694, filed Mar. 31, 2023, the disclosure of which is incorporated herein by reference in its entirety. Further, this application claims priority under 35 USC 119 from Japanese Patent Application No. 2022-089189 filed May 31, 2022, the disclosure of which is incorporated by reference herein.

### BACKGROUND OF THE INVENTION

### 1. Field of the Invention

A technique of the present disclosure relates to an optical system including a compound lens.

### 2. Description of the Related Art

JP6824424B discloses an apparatus for manufacturing a compound lens including a base lens and a resin layer that covers an optical surface of the base lens and has the shape of the optical surface.

JP1995-68568A (JP-H07-68568A) discloses a method of molding a compound optical element including: pressing an energy-curable resin placed on a substrate of an optical element with a mold of which a molding surface has a desired optical shape to form a resin layer; and irradiating the resin layer with energy to cure the resin layer.

JP1995-112491A (JP-H07-112491A) discloses a compound optical element that includes aspherical resin layers made of a thermal polymerization resin and formed on both surfaces of a glass substrate.

JP1996-258172A (JP-H08-258172A) discloses a method of manufacturing a plastic lens including: a first step of partially polymerizing a specific composition for a plastic lens with active energy rays to prevent the specific composition from being fluidized; and a second step of completely polymerizing the specific composition with subsequent heating.

WO2022/039143A discloses a compound from which a cured substance realizing not only a sufficiently low Abbe number but also excellent transmittance can be obtained, a curable resin composition that contains the compound, a cured substance that is obtained from the curable resin composition, and an optical member and a lens that contains this cured substance.

JP2009-248483A discloses a method of manufacturing a compound optical element including: a first jetting step of jetting a first resin to an optical element substrate or a mold; a first irradiation step of irradiating the first resin with curing energy to cure the first resin; a second jetting step of further jetting a second resin onto a surface of the cured first resin; a spreading step of causing the optical element substrate or the mold to be close to the second resin to spread the second resin; and a second irradiation step of irradiating the spread second resin with curing energy to cure the second resin.

JP2003-262708A discloses a compound optical element that includes an element substrate and a resin layer fixed to a surface of the element substrate.

JP3071277B discloses a method of manufacturing a lens that uses a glass member consisting of a substantially disk-shaped body portion and a barrel portion, which is connected to an outer peripheral edge of the body portion to surround the outer peripheral edge, as a base material and forms a resin layer having a predetermined surface shape on an optical functional surface, which is formed on a surface of the body portion and has an outer diameter smaller than an outer diameter of the body portion, by molding to form a lens in which the glass material and a resin material are integrated with each other.

JP4632942B discloses a resin-cemented optical element that includes an optical element substrate and a resin layer cemented to the optical element substrate.

JP2011-186440A discloses a compound optical element including: a glass substrate that includes a first optical functional surface facing one side in an optical axis direction, a second optical functional surface facing the other side in the optical axis direction, and an outer peripheral surface provided around the first optical functional surface; and a resin layer that is cemented to the second optical functional surface of the glass substrate.

JP1993-323104A (JP-H05-323104A) discloses a compound aspherical lens in which a synthetic resin layer including an aspherical surface is attached to and molded on a surface of a lens made of glass.

JP2005-060696A discloses a resin composition for a hybrid lens in which a resin composition used to form a resin layer of a hybrid lens including a resin layer cemented to a glass lens-base material contains a radically polymerizable monomer and a silane coupling agent.

JP2003-191260A discloses a device that cements a transparent resin film to a resin film-cemented surface, which is one surface of a lens made of glass, to give predetermined characteristics to the lens.

JP2018-151420A discloses a lens structure in which a first resin layer of which an indentation elastic modulus at a room temperature is greater than 0 MPa and is 3000 MPa or less is provided on a support, a second resin layer is provided on the first resin layer, and the amount of warpage of the support is 0 μm to 50 μm.

JP2015-219422A discloses an optical member that consists of a substrate and a resin and satisfies a specific expression in a case where a resin thickness of a thinnest portion of a main constituent pattern made of the resin is denoted by RTmin and a resin thickness of a thickest portion thereof is denoted by RTmax.

### SUMMARY OF THE INVENTION

One embodiment according to the technique of the present disclosure provides an optical system that can ensure the quality of a first lens.

According to a first aspect of the technique of the present disclosure, there is provided an optical system comprising a compound lens that includes a first lens and a second lens. The first lens is made of a resin and the second lens is made of glass. In a case where a maximum value of a thickness of the first lens is denoted by A [mm] and a minimum value of the thickness of the first lens is denoted by B [mm], Conditional Expressions (1) and (2), which are represented by A/B≤10 (1) and A≤3 mm (2), are satisfied. In a case where an amount of plastic deformation of the resin in a state where an indenter is pressed into the resin at a loading rate of 200 mN/10 sec at an environmental temperature of 25° C. is denoted by x [μm], the resin satisfies Conditional Expression (3) that is represented by 1.0 μm≤x≤4.0 μm (3).

According to a second aspect of the technique of the present disclosure, in the optical system according to the first aspect, Conditional Expressions (5) and (6), which are represented by A≥0.1 mm (5) and B≥0.02 mm (6), are satisfied.

According to a third aspect of the technique of the present disclosure, in the optical system according to the first or second aspect, a hardness of the resin at a temperature of 25° C. is 186 MPa or more and 196 MPa or less.

According to a fourth aspect of the technique of the present disclosure, in the optical system according to any one of the first to third aspects, a hardness of the resin at a temperature of 75° C. is 149 MPa or more and 164 MPa or less.

According to a fifth aspect of the technique of the present disclosure, in the optical system according to any one of the first to fourth aspects, an elastic recovery ratio of the resin at a temperature of 75° C. is 59% or more and 63% or less.

According to a sixth aspect of the technique of the present disclosure, in the optical system according to any one of the first to fifth aspects, an indentation elastic modulus of the resin at a temperature of 25° C. is 3.5 GPa or more and 3.6 GPa or less.

According to a seventh aspect of the technique of the present disclosure, in the optical system according to any one of the first to sixth aspects, an indentation elastic modulus of the resin at a temperature of 75° C. is 2.4 GPa or less.

According to an eighth aspect of the technique of the present disclosure, in the optical system according to any one of the first to seventh aspects, the resin has photocurability and a thermosetting property.

According to a ninth aspect of the technique of the present disclosure, in the optical system according to any one of the first to eighth aspects, the first lens is a lens that has a positive optical power and is made of the resin, and, in a case where a central thickness of the first lens is denoted by d, a curvature radius of a surface of the first lens facing an object side is denoted by Rf, and a curvature radius of a surface of the first lens facing an image side is denoted by Rr, Conditional Expression (7), which is represented by 0<d×(1/Rf−1/Rr)<0.05 (7), is satisfied.

According to a tenth aspect of the technique of the present disclosure, the optical system according to any one of the first to ninth aspects further comprises a front group, an aperture stop, and a rear group. The front group, the aperture stop, and the rear group are arranged in this order from an object side to an image side; the rear group includes at least one Lp lens that has a positive optical power and is made of the resin; and the first lens is the Lp lens. In a case where a sum of a distance on an optical axis between a lens surface of the front group closest to the object side and a lens surface of the rear group closest to the image side and an air conversion distance on the optical axis between the lens surface of the rear group closest to the image side and an image plane in a state where the optical system is focused on an infinite distance object is denoted by TL and a focal length of the Lp lens is denoted by fp, Conditional Expression (8), which is represented by 0.1<TL/fp<1.2 (8), is satisfied.

According to an eleventh aspect of the technique of the present disclosure, the optical system according to any one of the first to tenth aspects further comprises a front group, an aperture stop, and a rear group. The front group, the aperture stop, and the rear group are arranged in this order from an object side to an image side; the rear group includes at least one Lp lens that has a positive optical power and is made of the resin; and the first lens is the Lp lens. In a case where a height of a principal ray, which has a maximum half angle of view, from an optical axis on a surface of the Lp lens facing the object side in a state where the optical system is focused on an infinite distance object is denoted by Hpp and a height of an axial marginal ray from the optical axis on the surface of the Lp lens facing the object side in a state where the optical system is focused on the infinite distance object is denoted by Hpm, Conditional Expression (9), which is represented by 0.2<Hpp/Hpm<1.1 (9), is satisfied.

According to a twelfth aspect of the technique of the present disclosure, the optical system according to any one of the first to eleventh aspects further comprises a front group, an aperture stop, and a rear group. The front group, the aperture stop, and the rear group are arranged in this order from an object side to an image side; the rear group includes at least one Lp lens that has a positive optical power and is made of the resin; and the first lens is the Lp lens. In a case where a curvature radius of a surface of the Lp lens facing the image side is denoted by Rr, a distance on an optical axis between an image point, which is formed by an optical system ranging from a lens surface adjacent to an image side of the aperture stop to the surface of the Lp lens facing the image side, and the surface of the Lp lens facing the image side is denoted by De in a case where a point present at a position of the aperture stop on the optical axis is set as an object point in a state where the optical system is focused on an infinite distance object, De is calculated on an assumption that a medium closer to the image side than the surface of the Lp lens facing the image side is air, and a sign of De is set to be negative in a case where the image point is closer to the object side than the surface of the Lp lens facing the image side on the optical axis and is set to be positive in a case where the image point is closer to the image side than the surface of the Lp lens facing the image side, Conditional Expression (10), which is represented by −0.9<(De−Rr)/(De+Rr)<0.9 (10), is satisfied.

According to a thirteenth aspect of the technique of the present disclosure, the optical system according to any one of the first to twelfth aspects further comprises a front group, an aperture stop, and a rear group. The front group, the aperture stop, and the rear group are arranged in this order from an object side to an image side; the rear group includes at least one Lp lens that has a positive optical power and is made of the resin; and the first lens is the Lp lens. In a case where a focal length of a focus group moving along an optical axis during focusing is denoted by ffoc and a focal length of the Lp lens is denoted by fp, Conditional Expression (11), which is represented by 0.04<ffoc/fp<0.36 (11), is satisfied.

According to a fourteenth aspect of the technique of the present disclosure, the optical system according to any one of the first to thirteenth aspects further comprises a front group, an aperture stop, and a rear group. The front group, the aperture stop, and the rear group are arranged in this order from an object side to an image side; and the first lens is an Lp lens that has a positive optical power and is made of the resin. In a case where a maximum angle of view in a state where the optical system is focused on an infinite distance object is denoted by ωm, the rear group includes the Lp lens in a case where Conditional Expression (12), which is represented by ωm≥450 (12), is satisfied and the front group includes the Lp lens in a case where Conditional Expression (13), which is represented by ωm<45° (13), is satisfied.

According to a fifteenth aspect of the technique of the present disclosure, the optical system according to any one of the first to fourteenth aspects further comprises a front group, an aperture stop, and a rear group. The front group, the aperture stop, and the rear group are arranged in this order from an object side to an image side; the rear group includes at least one Lp lens that has a positive optical power and is made of the resin; and the first lens is the Lp lens. In a case where a central thickness of the Lp lens is denoted by A, a thickness of the compound lens in an optical axis direction at a maximum effective diameter height on both surfaces of the Lp lens is denoted by B, a maximum image height is denoted by Y, a partial dispersion ratio of the Lp lens between a g line and an F line is denoted by θgF, an Abbe number of the Lp lens with respect to a d line is denoted by νd, and ΔθgF is represented by Conditional Expression (14) [ΔθgF=θgF−(0.6438−0.001682×νd) (14)], Conditional Expression (15), which is represented by 0.004<(|A−B|ΔθgF)/Y<0.020 (15), is satisfied.

According to a sixteenth aspect of the technique of the present disclosure, the optical system according to any one of the first to fifteenth aspects further comprises a front group, an aperture stop, and a rear group. The front group, the aperture stop, and the rear group are arranged in this order from an object side to an image side; the compound lens is included in the front group; and the second lens is disposed closer to the object side than the first lens.

According to a seventeenth aspect of the technique of the present disclosure, the optical system according to any one of the first to fifteenth aspects further comprises a front group, an aperture stop, and a rear group. The front group, the aperture stop, and the rear group are arranged in this order from an object side to an image side; the compound lens is included in the rear group; and the second lens is disposed closer to the image side than the first lens.

According to an eighteenth aspect according to the technique of the present disclosure, there is provided an optical system comprising a compound lens that includes a first lens and a second lens. The first lens includes a convex surface and a first surface that protrudes from an outer peripheral edge of the convex surface to an outside in a radial direction of the compound lens, and the second lens includes a concave surface that is cemented to the convex surface and a second surface that protrudes from an outer peripheral edge of the concave surface to the outside in the radial direction and is cemented to the first surface. In a case where a length of the first surface along the radial direction is denoted by a [μm], a length of the second surface along the radial direction is denoted by b [μm], and a surface roughness of the second surface is denoted by Ra [μm], Conditional Expressions (16) and (17), which are represented by a<b (16) and 5 μm≤a/Ra (17), are satisfied.

### BRIEF DESCRIPTION OF THE DRAWINGS

FIG. 1 is a longitudinal sectional view showing an example of a compound lens.

FIG. 2 is a longitudinal sectional view showing an example of a dimensional relationship of the compound lens.

FIG. 3 is a diagram showing an example of a method of manufacturing the compound lens.

FIG. 4 is a longitudinal sectional view illustrating an example of a problem of the compound lens.

FIG. 5 is a graph showing an example of a load-displacement curve in a microhardness test.

FIG. 6 is a longitudinal sectional view showing an example of an imaging lens.

FIG. 7 is a longitudinal sectional view showing an example of a distance De in the imaging lens.

FIG. 8 is a longitudinal sectional view showing an example of a height Hpp and a height Hpm in the imaging lens.

FIG. 9 is a longitudinal sectional view showing an example of an imaging lens according to Example 1.

FIG. 10 is a diagram showing aberrations of the imaging lens according to Example 1.

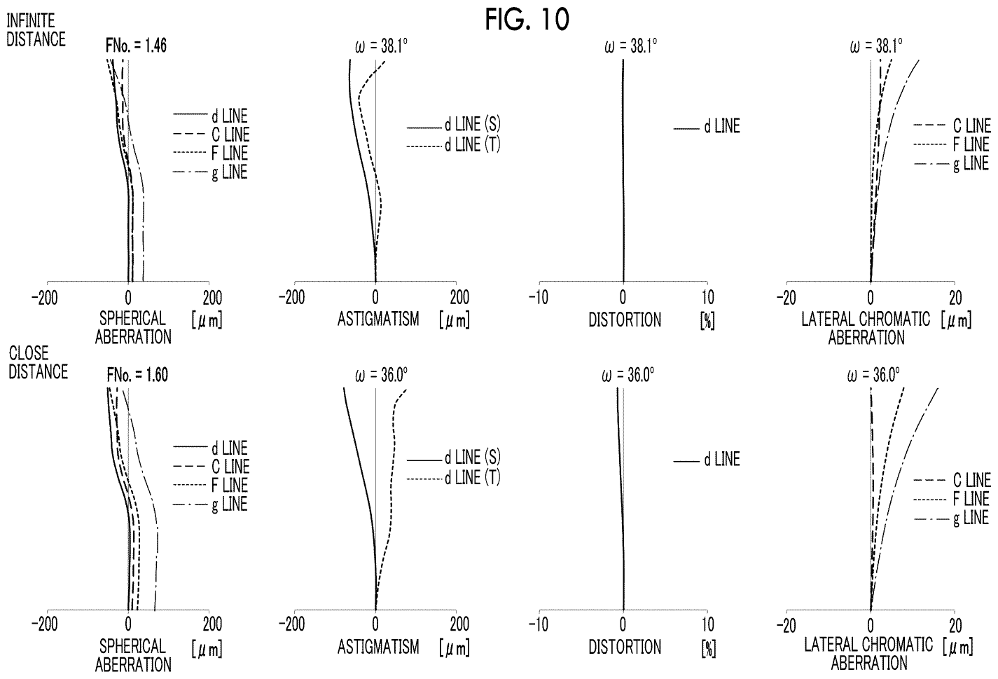

FIG. 11 is a longitudinal sectional view showing an example of an imaging lens according to Example 2.

FIG. 12 is a diagram showing aberrations of the imaging lens according to Example 2.

### DESCRIPTION OF THE PREFERRED EMBODIMENTS

Hereinafter, an example of an embodiment of an optical system according to the technique of the present disclosure will be described with reference to the accompanying drawings.

In the description of the present specification, the term “orthogonal” refers to not only being completely orthogonal but also being orthogonal in a sense including an error that is generally allowed in the technical field to which the technique of the present disclosure belongs and that does not contradict the gist of the technique of the present disclosure. In the description of the present specification, the term “parallel” refers to not only being completely parallel but also being parallel in a sense including an error that is generally allowed in the technical field to which the technique of the present disclosure belongs and that does not contradict the gist of the technique of the present disclosure. In the description of the present specification, the term “flat surface” refers to not only a completely flat surface but also a flat surface in a sense including an error that is generally allowed in the technical field to which the technique of the present disclosure belongs and that does not contradict the gist of the technique of the present disclosure.

### (Configuration of Compound Lens)

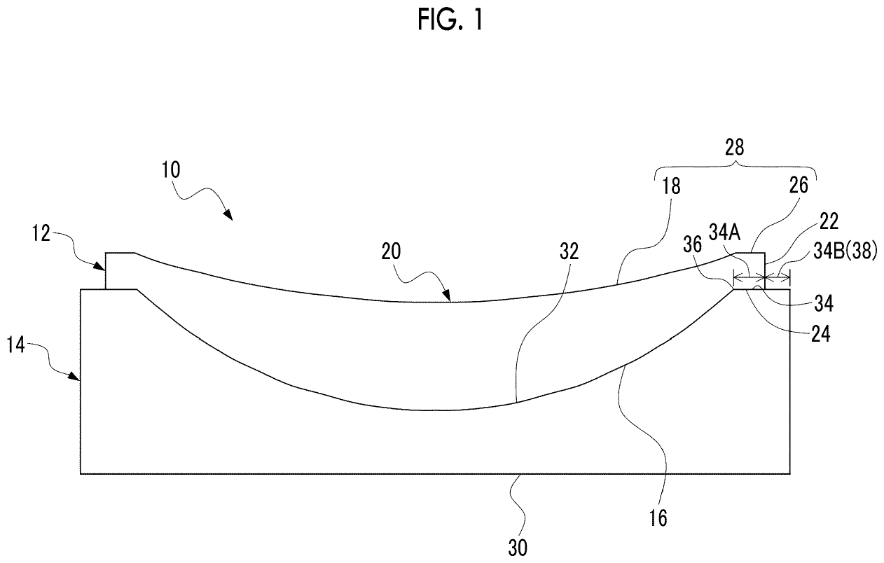

First, an example of a configuration of a compound lens 10 will be described. For example, as shown in FIG. 1, the compound lens 10 includes a first lens 12 and a second lens 14. Both the first lens 12 and the second lens 14 are formed in a circular shape as viewed in an optical axis direction of the compound lens 10. The first lens 12 is made of a resin, and the second lens 14 is made of glass.

For example, the first lens 12 is a concave meniscus lens and includes a convex surface 16 and a concave surface 18. The convex surface 16 is formed in a convex shape, and the concave surface 18 is formed in a concave shape. The concave surface 18 is a surface that is positioned on a side opposite to the convex surface 16 in the optical axis direction of the compound lens 10. The convex surface 16 and the concave surface 18 are formed on a lens body 20 of the first lens 12. The lens body 20 is a portion that defines an effective diameter of the first lens 12.

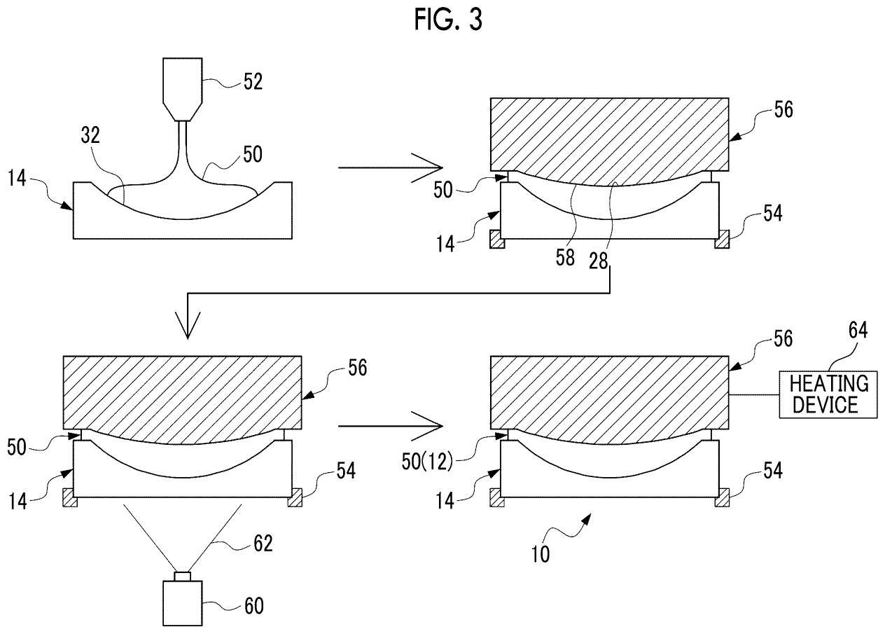

Further, the first lens 12 includes a flange 22. The flange 22 protrudes from an outer peripheral edge of the lens body 20 to the outside in a radial direction of the compound lens 10. The flange 22 is formed in an annular shape along the outer peripheral edge of the lens body 20. The flange 22 includes a first flange surface 24 and a second flange surface 26. The first flange surface 24 protrudes from an outer peripheral edge of the convex surface 16 to the outside in the radial direction of the compound lens 10, and the second flange surface 26 protrudes from an outer peripheral edge of the concave surface 18 to the outside in the radial direction of the compound lens 10. For example, both the first flange surface 24 and the second flange surface 26 extend in a direction orthogonal to the optical axis direction of the compound lens 10. The concave surface 18 and the second flange surface 26 form a molded surface 28 that is molded by a mold 56 (see FIG. 3) to be described later.

For example, the second lens 14 is a plano-concave lens and includes a flat surface 30 and a concave surface 32. The flat surface 30 is formed in a planar shape, and the concave surface 32 is formed in a concave shape. The concave surface 32 is a surface that is positioned on a side opposite to the flat surface 30 in the optical axis direction of the compound lens 10. The convex surface 16 of the first lens 12 is cemented to the concave surface 32. Further, the second lens 14 includes a sliding surface 34. The sliding surface 34 is formed of a rough surface having unevenness. The sliding surface 34 protrudes from an outer peripheral edge of the concave surface 32 to the outside in the radial direction of the compound lens 10. For example, the sliding surface 34 extends in a direction orthogonal to the optical axis direction of the compound lens 10. A ridge 36 is formed between the concave surface 32 and the sliding surface 34. The ridge 36 is formed in an annular shape along the outer peripheral edge of the concave surface 32.

The first flange surface 24 is cemented to the sliding surface 34. For example, the first flange surface 24 is cemented to a first region 34A of the sliding surface 34 close to the concave surface 32. A second region 34B of the sliding surface 34, which excludes the first region 34A, is used, for example, as a grip portion in a case where the compound lens 10 is gripped by a grip device (not shown). That is, a portion of the compound lens 10 including the second region 34B is a portion 38 to be gripped by the grip device.

A plano-concave lens is applied as an example of the second lens 14 in an example shown in FIG. 1, but the second lens 14 may be a biconcave lens including a concave surface instead of the flat surface 30. Further, the second lens 14 may be a concave meniscus lens including a convex surface instead of the flat surface 30.

The compound lens 10 is an example of a “compound lens” according to the technique of the present disclosure. The first lens 12 is an example of a “first lens” according to the technique of the present disclosure. The second lens 14 is an example of a “second lens” according to the technique of the present disclosure. The convex surface 16 is an example of a “convex surface” according to the technique of the present disclosure. The concave surface 18 is an example of a “concave surface” according to the technique of the present disclosure. The first flange surface 24 is an example of a “first surface” according to the technique of the present disclosure. The sliding surface 34 is an example of a “second surface” according to the technique of the present disclosure. The second flange surface 26 is an example of a “third surface” according to the technique of the present disclosure.

### (Dimensional Relationship of Compound Lens)

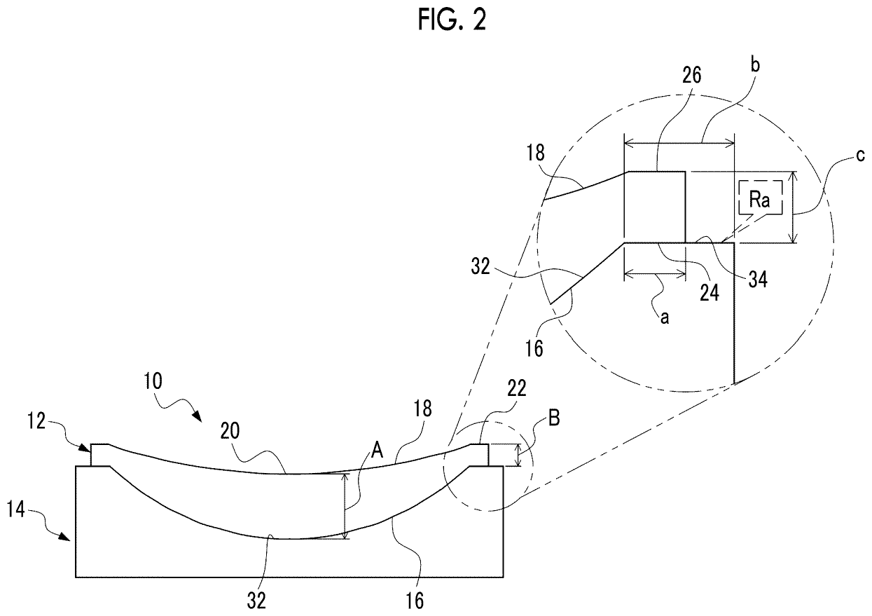

Subsequently, a dimensional relationship of the compound lens 10 will be described. For example, as shown in FIG. 2, in the following description, a length of the first flange surface 24 along the radial direction of the compound lens 10 will be referred to as a “length a”, and a length of the sliding surface 34 along the radial direction of the compound lens 10 will be referred to as a “length b”. Further, a length from the first flange surface 24 to the second flange surface 26 along the optical axis direction of the compound lens 10 will be referred to as a “length c”, and a surface roughness of the sliding surface 34 will be referred to as a “surface roughness Ra”. All of the units of the length a, the length b, the length c, and the surface roughness Ra are “m (micrometer)”.

Furthermore, a maximum value of the thicknesses of the first lens 12 will be referred to as a “maximum thickness A”, and a minimum value of the thicknesses of the first lens 12 will be referred to as a “minimum thickness B”. All of the units of the maximum thickness A and the minimum thickness are “mm (millimeter)”. A thickness of the first lens 12 is defined by a length from the convex surface 16 to the concave surface 18 along the optical axis direction of the compound lens 10. For example, the maximum thickness A corresponds to the thickness of the first lens 12 at a center of the first lens 12. In addition, for example, the minimum thickness B corresponds to a thickness of an end portion of the lens body 20 close to the flange 22.

### (Dimensions Applied to Compound Lens)

Subsequently, an example of dimensions applied to the compound lens 10 will be described. A difference between the thickness of the first lens 12 at a center of the convex surface 16 and the thickness of the first lens 12 at the first flange surface 24 (that is, a thickness of the flange 22) is 0.01 mm or more and 1 mm or less. An effective diameter of the convex surface 16 is 3 mm or more and 50 mm or less. An outer diameter of the second lens 14 is 4 mm or more and 110 mm or less. A thickness of the second lens 14 at a center of the concave surface 32 is 0.5 mm or more and 10 mm or less. An effective diameter of the concave surface 32 is 3 mm or more and 50 mm or less. A curvature radius of the concave surface 32 is 5 mm or more and 300 mm or less. A curvature radius of the convex surface 16 is the same as the curvature radius of the concave surface 32. The above-mentioned dimensions are merely an example, and the dimensions of the compound lens 10 may be dimensions other than the above-mentioned dimensions.

### (Material Applied to First Lens and Second Lens)

Subsequently, an example of a material applied to the first lens 12 and the second lens 14 will be described. For example, the first lens 12 is made of a photocurable/thermosetting resin having photocurability and a thermosetting property. Specifically, the first lens 12 is made of a mixed resin of a photocurable resin having photocurability and a thermosetting resin having a thermosetting property. Examples of the photocurable/thermosetting resin forming the first lens 12 include a curable resin disclosed in WO2022/039143A.

For example, a coefficient of thermal expansion of the first lens 12 is 6×10⁻⁵/° C., and an elastic modulus of the first lens 12 is 2.5×10⁹ Pa. Examples of the glass forming the second lens 14 include S-FPL5 manufactured by OHARA Inc. For example, a coefficient of thermal expansion of the second lens 14 is 0.77×10⁻⁵/° C., and an elastic modulus of the second lens 14 is 106.7×10⁹ Pa.

### (Method of Manufacturing Compound Lens)

Subsequently, an example of a method of manufacturing the compound lens 10 will be described. In an example shown in FIG. 3, a resin 50 is used as the resin for forming the first lens 12. The resin 50 is a photocurable/thermosetting resin. In the method of manufacturing the compound lens 10, first, the uncured resin 50 is supplied onto the concave surface 32 by a supply device 52. Next, the resin 50 is pressed against the second lens 14 from a side opposite to the second lens 14 by the mold 56 in a state where the second lens 14 is held by a jig 54. A molding surface 58 having a shape in which the molded surface 28 is inverted is formed on the mold 56. The molded surface 28 is formed on the resin 50 by the molding surface 58.

Next, light 62 is output from a light source 60 that is disposed on a side opposite to the resin 50 and the mold 56. The light 62 is light having a wavelength range in which the resin 50 is cured. The light 62 output from the light source 60 transmits through the second lens 14 and the resin 50 is irradiated with the light 62. In a case where the resin 50 is irradiated with the light 62, a photocurable resin contained in the resin 50 is subjected to a curing reaction and the resin 50 is in a semi-cured state. After that, the mold 56 is heated by a heating device 64. Heat of the mold 56 heated by the heating device 64 is transferred to the resin 50, so that the resin 50 is heated. Then, a thermosetting resin contained in the resin 50 is subjected to a curing reaction, so that the resin 50 is in a cured state. In a case where the resin 50 is cured, the first lens 12 integrated with the second lens 14 is formed. The compound lens 10 including the first lens 12 and the second lens 14 is manufactured in the above-mentioned manner.

### (Problem of Compound Lens)

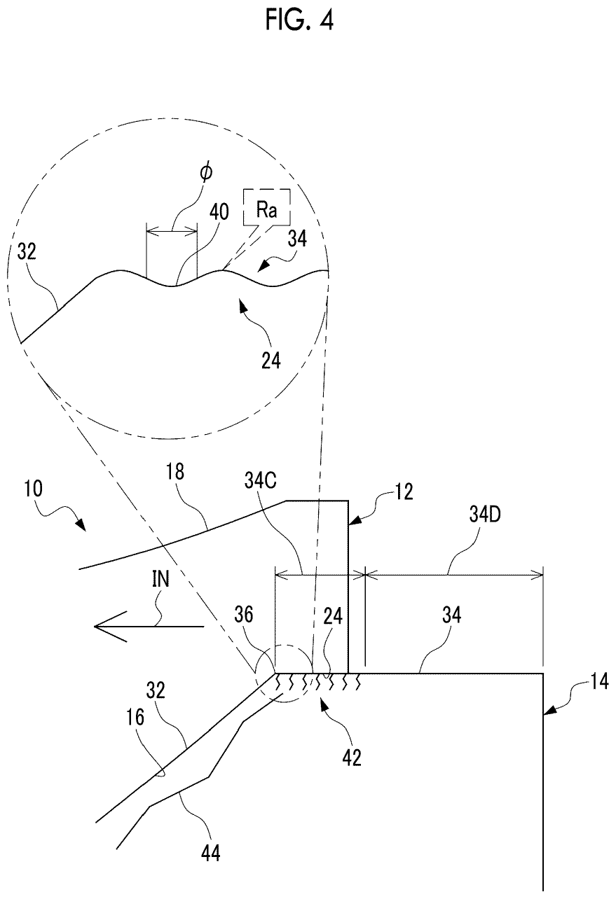

Subsequently, a problem of the compound lens 10 will be described. For example, as shown in FIG. 4, an uneven shape is formed on the sliding surface 34. The uneven shape formed on the sliding surface 34 is engaged with an uneven shape formed on the first flange surface 24. A diameter φ of a concave portion 40 included in the uneven shape formed on the sliding surface 34 is about 50 μm. For easy understanding of the uneven shape, the size of the uneven shape is exaggerated in FIG. 4.

The sliding surface 34 is formed by, for example, polishing. A plurality of microcracks 42 occur in a region of the sliding surface 34 close to a boundary with the concave surface 32 (hereinafter, referred to as a “boundary region 34C”) due to the polishing. The microcracks 42 occur due to the concentration of stress in the boundary region 34C in a case where the sliding surface 34 is subjected to polishing. The reason why stress is concentrated in the boundary region 34C is that the boundary region 34C abuts on the ridge 36. A region adjacent to the boundary region 34C (hereinafter, referred to as an “adjacent region 34D”) is a region that does not include the microcracks 42 since the region is separated from the ridge 36 and stress is relaxed therein.

In an example shown in FIG. 4, the first flange surface 24 is cemented to only the boundary region 34C of the sliding surface 34. That is, the first flange surface 24 is included in a range of the length of the boundary region 34C. In a case where the first lens 12 is deformed to the inside in the radial direction of the compound lens 10 (the side of an arrow IN) due to cure shrinkage, thermal shrinkage, and/or the like in the example shown in FIG. 4, the sliding surface 34 is pulled by the first flange surface 24. For this reason, there is a concern that cracks 44 occur from the sliding surface 34 toward the inside of the second lens 14 with the microcracks 42 as starting points. In a case where the number and/or size of the cracks 44 exceeds an allowable range, there is a concern that the second lens 14 may be broken by a physical force generated due to the deformation of the first lens 12.

Here, it is considered to reduce the value of the surface roughness Ra in order to suppress a force with which the sliding surface 34 is pulled by the first flange surface 24. However, there is a possibility that optical defects occur in the compound lens 10 since light is reflected from the sliding surface 34 in a case where the value of the surface roughness Ra is reduced.

Accordingly, the compound lens 10 is required to prevent the occurrence of optical defects due to the reflection of light from the sliding surface 34 and to prevent the breakage of the second lens 14 caused by a physical force generated due to the deformation of the first lens 12. Further, the first lens 12 made of a resin is required to ensure quality related to optical performance.

### (Examples and Comparative Examples of Compound Lens)

Subsequently, an example of cases where the length a, the length c, and the surface roughness Ra are set to be different in Examples and Comparative examples of the compound lens 10 will be described with reference to Table 1. Examples of evaluation items for Examples and Comparative examples include “occurrence of cracks”, “optical characteristics”, and “gripability”.

The “occurrence of cracks” is evaluated as “excellent”, “good”, or “unacceptable” in terms of the occurrence of the cracks 44 with the microcracks 42 present in the boundary region 34C of the sliding surface 34 as starting points. A fact that the “occurrence of cracks” is “excellent” indicates that the cracks 44 do not occur and the breakage of the second lens 14 can be prevented. A fact that the “occurrence of cracks” is “good” indicates that the cracks 44 occur but the number and/or size of the cracks 44 is within the allowable range and the breakage of the second lens 14 can be prevented. A fact that the “occurrence of cracks” is “unacceptable” indicates that the number and/or size of the cracks 44 is out of the allowable range and the second lens 14 is broken.

The “optical characteristics” are evaluated as “excellent”, “good”, or “unacceptable” in terms of optical characteristics of the compound lens 10. As the sliding surface 34 approaches a flat surface, the intensity of light reflected from the sliding surface 34 is increased and the optical characteristics of the compound lens 10 are affected. A fact that the “optical characteristics” are “excellent” indicates that the optical characteristics of the compound lens 10 are not affected and that the occurrence of optical defects in the compound lens 10 can be prevented. A fact that the “optical characteristics” are “good” indicates that the optical characteristics of the compound lens 10 are affected but the occurrence of optical defects in the compound lens 10 can be prevented since the intensity of light reflected from the sliding surface 34 is within an allowable range. A fact that the “optical characteristics” are “unacceptable” indicates that the intensity of light reflected from the sliding surface 34 is out of the allowable range and optical defects occur in the compound lens 10.

The “grippability” is evaluated as “excellent”, “good”, or “unacceptable” in terms of workability in a case where the portion 38 to be gripped is gripped by the grip device. As described above, the compound lens 10 includes the portion 38 to be gripped, and transport work and assembly work are performed in a state where the portion 38 to be gripped is gripped by the grip device. A fact that the “grippability” is “excellent” indicates that the stability of the compound lens 10 is ensured in a case where the portion 38 to be gripped is gripped by the grip device since the length of the portion 38 to be gripped is longer than the minimum length required for the portion 38 to be gripped to be gripped by the grip device. A fact that the “grippability” is “good” indicates that the stability of the compound lens 10 is ensured in a case where the portion 38 to be gripped is gripped by the grip device since the length of the portion 38 to be gripped is set to the minimum length required for the portion 38 to be gripped to be gripped by the grip device. A fact that the “gripability” is “unacceptable” indicates that the portion 38 to be gripped cannot be gripped by the grip device since the length of the portion 38 to be gripped is shorter than the minimum length required for the portion 38 to be gripped to be gripped by the grip device.

TABLE 1

| | | | | | Occurrence of | Optical | |
|---|---|---|---|---|---|---|---|
| | | a [μm] | c [μm] | Ra [μm] | cracks | characteristics | Gripability |
| 1 | Example | 150 | 150 | 3 | Excellent | Excellent | Excellent |
| 2 | Example | 150 | 150 | 20 | Good | Excellent | Excellent |
| 3 | Comparative | 150 | 150 | 21 | Unacceptable | Excellent | Excellent |
| | Example | | | | | | |
| 4 | Comparative | 150 | 150 | 22 | Unacceptable | Excellent | Excellent |
| | Example | | | | | | |
| 5 | Comparative | 150 | 150 | 25 | Unacceptable | Excellent | Excellent |
| | Example | | | | | | |
| 6 | Comparative | 150 | 150 | 0.4 | Excellent | Unacceptable | Excellent |
| | Example | | | | | | |
| 7 | Example | 150 | 150 | 0.5 | Excellent | Good | Excellent |
| 8 | Example | 100 | 150 | 3 | Good | Excellent | Excellent |
| 9 | Comparative | 50 | 150 | 3 | Unacceptable | Excellent | Excellent |
| | Example | | | | | | |
| 10 | Example | 150 | 200 | 3 | Excellent | Excellent | Excellent |
| 11 | Example | 150 | 300 | 3 | Good | Excellent | Excellent |
| 12 | Comparative | 150 | 350 | 3 | Unacceptable | Excellent | Excellent |
| | Example | | | | | | |
| 13 | Example | 500 | 150 | 3 | Excellent | Excellent | Excellent |
| 14 | Example | 800 | 150 | 3 | Excellent | Excellent | Excellent |
| 15 | Example | 1000 | 150 | 3 | Excellent | Excellent | Excellent |
| 16 | Comparative | 1100 | 150 | 3 | Excellent | Excellent | Unacceptable |
| | Example | | | | | | |
| 17 | Example | 150 | 100 | 3 | Excellent | Excellent | Excellent |
| 18 | Example | 150 | 50 | 3 | Excellent | Excellent | Excellent |
| 19 | Example | 150 | 10 | 3 | Excellent | Good | Excellent |
| 20 | Comparative | 150 | 9 | 3 | Excellent | Unacceptable | Excellent |
| | Example | | | | | | |

From Examples and Comparative examples shown in Table 1, it is preferable that the compound lens 10 satisfies Conditional Expressions (1), (2), and (3) to be described below.

$$a < b \qquad ( 1 )$$

$$100 μm \leq a \qquad ( 2 )$$

$$0.5 μm \leq Ra \leq 20 μm \qquad ( 3 )$$

In a case where the length a is less than 100 μm in Conditional Expression (2), the second lens 14 is broken since the cracks 44 occur. In a case where the length a is 100 μm or more in Conditional Expression (2), the breakage of the second lens 14 can be prevented since the occurrence of the cracks 44 is suppressed. It is presumed that the reason why the occurrence of the cracks 44 with the microcracks 42 present in the boundary region 34C of the sliding surface 34 as starting points is suppressed in a case where the length a is 100 μm or more is that the first flange surface 24 is cemented not only to the boundary region 34C including the microcracks 42 but also to the adjacent region 34D (that is, a region not including the microcracks 42) adjacent to the boundary region 34C.

In a case where the surface roughness Ra is less than 0.5 μm in Conditional Expression (3), the optical characteristics of the compound lens 10 are affected by light reflected from the sliding surface 34, so that optical defects occur in the compound lens 10. In a case where the surface roughness Ra is 0.5 μm or more in Conditional Expression (3), an influence of light reflected from the sliding surface 34 on the optical characteristics of the compound lens 10 is suppressed, so that the occurrence of optical defects in the compound lens 10 can be prevented. In a case where the surface roughness Ra exceeds 20 μm in Conditional Expression (3), the cracks 44 occur with the microcracks 42 present in the boundary region 34C of the sliding surface 34 as starting points, so that the second lens 14 is broken. In a case where the surface roughness Ra is 20 μm or less in Conditional Expression (3), the occurrence of the cracks 44 with the microcracks 42 present in the boundary region 34C of the sliding surface 34 as starting points is suppressed, so that the breakage of the second lens 14 can be prevented. It is presumed that the reason why the occurrence of the cracks 44 with the microcracks 42 present in the boundary region 34C of the sliding surface 34 as starting points is suppressed in a case where the surface roughness Ra is 20 μm or less is that a physical force generated in the boundary region 34C of the sliding surface 34 due to the deformation of the first lens 12 is suppressed due to the suppression of an engagement force between the uneven shape of the sliding surface 34 and the uneven shape of the first flange surface 24.

An influence of a difference in a coefficient of thermal expansion between the glass and the resin on the breakage of the second lens 14 is smaller than an influence of the elastic modulus of the resin on the breakage of the second lens 14. Further, as the elastic modulus of the resin is lower, the cracks 44 are less likely to occur. However, as a result of intensive studies conducted by the present inventors, it was experimentally found that the influence of the length a, the length c, and the surface roughness Ra is greater than the influence of the elastic modulus of the resin.

Furthermore, from Examples and Comparative Examples shown in Table 1, it is preferable that the compound lens 10 satisfies Conditional Expression (4) to be described below.

$$b - a \geq 700 μm \qquad ( 4 )$$

In Examples and Comparative examples of the compound lens 10, the length b is set to 1700 μm. In Table 1, a fact that a corresponding value of Conditional Expression (4) is 700 m or more corresponds to a fact that the length a is 1000 μm or less. In a case where the corresponding value of Conditional Expression (4) is less than 700 μm, the grip device interferes with the flange 22 and the portion 38 to be gripped cannot be gripped by the grip device. For this reason, it is difficult to assemble the compound lens 10 with an imaging lens. In a case where the corresponding value of Conditional Expression (4) is 700 μm or more and the grip device is to grip the portion 38 to be gripped, interference between the grip device and the flange 22 is avoided and the stability of the compound lens 10 is ensured. Accordingly, workability in a case where the compound lens 10 is assembled with the imaging lens is ensured.

Further, it is more preferable that the compound lens 10 satisfies Conditional Expression (5) to be described below.

$$5 \leq a / Ra \qquad ( 5 )$$

In a case where a corresponding value of Conditional Expression (5) is 5 or more, it is possible to more effectively prevent the occurrence of optical defects that is caused by the reflection of light from the second surface and the breakage of the second lens 14 that is caused by a physical force generated due to the deformation of the first lens 12.

Furthermore, it is more preferable that the compound lens 10 satisfies Conditional Expression (6) to be described below.

$$10 μm \leq c \leq 300 μm \qquad ( 6 )$$

In a case where the length c is less than 10 μm in Conditional Expression (6) and the resin 50 is supplied onto the concave surface 32 by the supply device 52, a variation in the amount of the resin 50 cannot be allowed and the length a is not stable. In a case where the length c is 10 μm or more in Conditional Expression (6) and the resin 50 is supplied onto the concave surface 32 by the supply device 52, a variation in the amount of the resin 50 can be allowed and the length a is stable. Further, in a case where the length c exceeds 300 μm in Conditional Expression (6), the second lens 14 is broken due to the occurrence of the cracks 44. In a case where the length c is 300 μm or less in Conditional Expression (6), the occurrence of the cracks 44 is suppressed. As a result, it is possible to prevent the breakage of the second lens 14.

In addition, it is more preferable that the compound lens 10 satisfies Conditional Expression (7) to be described below.

$$100 μm \leq c \leq 300 μm \qquad ( 7 )$$

In a case where the length c is 100 μm or more in Conditional Expression (7), an effect obtained in a case where the length c is 10 μm or more is further enhanced. Further, in a case where the length c is 100 μm or more in Conditional Expression (7), the first lens 12 is easily manufactured as compared to a case where the length c is less than 100 μm.

Furthermore, it is more preferable that the compound lens 10 satisfies Conditional Expression (8) to be described below.

$$1 μm \leq Ra \leq 4 μm \qquad ( 8 )$$

In a case where the surface roughness Ra is 1 μm or more in Conditional Expression (8), an effect obtained in a case where the surface roughness Ra is 0.5 μm or more is further enhanced. In a case where the surface roughness Ra is 4 μm or less in Conditional Expression (8), an effect obtained in a case where the surface roughness Ra is 20 μm or less is further enhanced.

Subsequently, an example of cases where the maximum thickness A and the minimum thickness B are set to be different in Examples and Comparative examples of the first lens 12 will be described with reference to Table 2. In Table 2, a thickness deviation ratio A/B indicating a ratio of the maximum thickness A to the minimum thickness B is shown as a parameter in addition to the maximum thickness A and the minimum thickness B. Examples of evaluation items for Examples and Comparative examples include “quality of first lens”.

The “quality of first lens” is evaluated as “excellent”, “good”, or “unacceptable” in terms of, for example, the quality of the molded surface 28 molded by the mold 56. A fact that the “quality of first lens” is “excellent” indicates that quality related to the optical performance of the first lens 12 can be ensured since the occurrence of air bubbles and transfer failure on the molded surface 28 is prevented in a case where the resin 50 is molded by the mold 56. The transfer failure occurs since a pressing force applied by the mold 56 at a portion of the first lens 12 corresponding to the maximum thickness A (hereinafter, referred to as a “maximum thickness portion”) is insufficient. A fact that the “quality of first lens” is “good” indicates that air bubbles and/or transfer failure occurs on the molded surface 28 but quality related to the optical performance of the first lens 12 can be ensured since the number and/or size of regions in which the air bubbles and/or the transfer failure occurs is within an allowable range. A fact that the “quality of first lens” is “unacceptable” indicates that quality related to the optical performance of the first lens 12 is insufficient since the number and/or size of regions in which the air bubbles and/or the transfer failure occurs is out of the allowable range.

TABLE 2

| | | A | B | | Quality of |
|---|---|---|---|---|---|
| | | [mm] | [mm] | A/B | first lens |
| 1 | Example | 1 | 0.2 | 5 | Excellent |
| 2 | Example | 1.8 | 0.2 | 9 | Excellent |
| 3 | Example | 2.9 | 0.4 | 7.25 | Excellent |
| 4 | Example | 3 | 0.4 | 7.5 | Good |
| 5 | Comparative Example | 3.1 | 0.4 | 7.75 | Unacceptable |
| 6 | Example | 0.5 | 0.1 | 5 | Excellent |
| 7 | Example | 0.3 | 0.1 | 3 | Excellent |
| 8 | Example | 0.1 | 0.03 | 3.3 | Good |
| 9 | Comparative Example | 0.09 | 0.03 | 3 | Unacceptable |
| 10 | Example | 0.3 | 0.02 | 1.5 | Good |
| 11 | Comparative Example | 0.09 | 0.01 | 9 | Unacceptable |
| 12 | Example | 1 | 0.1 | 10 | Good |
| 13 | Comparative Example | 1 | 0.09 | 11.1 | Unacceptable |

From Examples and Comparative Examples shown in Table 2, it is preferable that the first lens 12 satisfies Conditional Expressions (9) and (10) to be described below.

$$A / B \leq 10 \qquad ( 9 )$$

$$A \leq 3 mm \qquad ( 10 )$$

In a case where the thickness deviation ratio A/B is greater than 10 in Conditional Expression (9), quality related to the optical performance of the first lens 12 is insufficient since air bubbles occur on the molded surface 28. In a case where the thickness deviation ratio A/B is 10 or less in Conditional Expression (9), quality related to the optical performance of the first lens 12 is ensured since the occurrence of air bubbles and transfer failure on the molded surface 28 is suppressed. In a case where the maximum thickness A is greater than 3 mm in Conditional Expression (10), quality related to the optical performance of the first lens 12 is insufficient since air bubbles occur on the molded surface 28. In a case where the maximum thickness A is 3 mm or less in Conditional Expression (10), quality related to the optical performance of the first lens 12 is ensured since the occurrence of air bubbles and transfer failure on the molded surface 28 is suppressed.

Further, from Examples and Comparative Examples shown in Table 2, it is preferable that the first lens 12 satisfies Conditional Expressions (11) and (12) to be described below.

$$A \geq 0.1 mm \qquad ( 11 )$$

$$B \geq 0.02 mm \qquad ( 12 )$$

In a case where the maximum thickness A is less than 0.1 mm in Conditional Expression (11), quality related to the optical performance of the first lens 12 is insufficient since transfer failure occurs on the molded surface 28. In a case where the maximum thickness A is 0.1 mm or more in Conditional Expression (11), quality related to the optical performance of the first lens 12 is ensured since the occurrence of air bubbles and transfer failure on the molded surface 28 is suppressed. In a case where the minimum thickness B is less than 0.02 mm in Conditional Expression (12), quality related to the optical performance of the first lens 12 is insufficient since air bubbles occur on the molded surface 28. In a case where the minimum thickness B is 0.02 mm or more in Conditional Expression (12), quality related to the optical performance of the first lens 12 is ensured since the occurrence of bubbles and transfer failure on the molded surface 28 is suppressed.

### (Microhardness Test for Resin)

Subsequently, an example of a microhardness test performed on the resin applied to the first lens 12 will be described. For example, a dynamic microhardness tester DUH-211S manufactured by Shimadzu Corporation is used in the microhardness test. A Berkovich indenter is used as an indenter. Other measuring devices similar to the dynamic microhardness tester DUH-211S manufactured by Shimadzu Corporation may be used in the microhardness test.

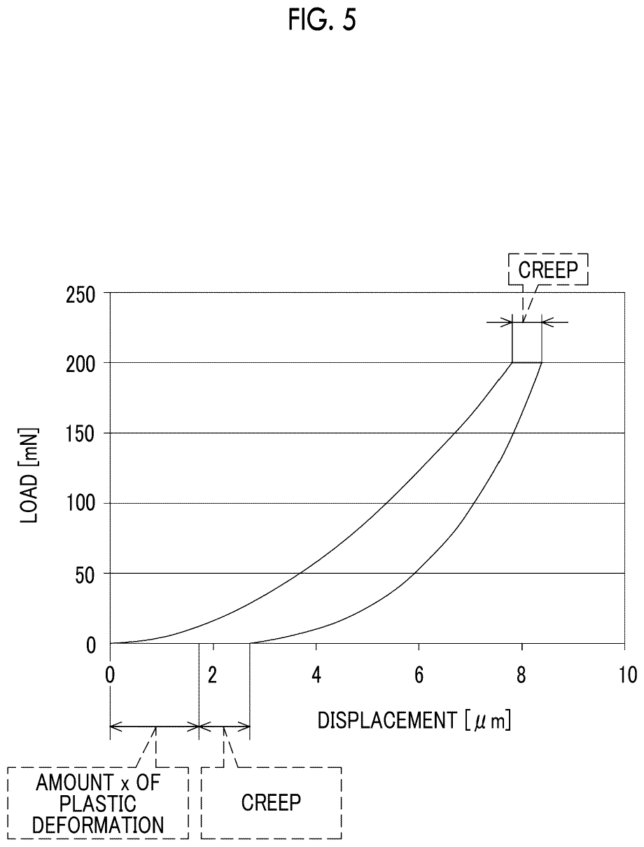

In the microhardness test, a flat plate-like test piece having a diameter of 7.4 mm and a thickness of 1.3 mm is used as an example of a test piece of the cured resin. The thickness of the test piece is generally set to about 10 times the amount x of plastic deformation (see FIG. 5) to be described later. Accordingly, the thickness of the resin does not need to be 1.3 mm, and the thickness of the resin may be 50 μm, 100 μm, 200 μm, or the like, for example, in a case where the amount of plastic deformation is 5 μm. Further, the resin used in the microhardness test does not need to have a flat plate shape as long as the condition of the thickness is satisfied. The test piece is disposed in an environment in which an environmental temperature is set to 25° C. For example, the test piece is placed on a hot plate set at a temperature of 25° C. The temperature of 25° C. is a temperature that simulates a room temperature. A constant-temperature tank may be used instead of the hot plate, and the temperature of the constant-temperature tank may be set to 25° C. The test piece is pressed by the indenter at a loading rate of 200 mN/10 sec in a state where the environmental temperature is 25° C.

For example, a load-displacement curve in a case where the indenter is pressed into the test piece in the microhardness test is shown in FIG. 5. For example, each of a state where the maximum load is applied and a state where a load is removed is held for 5 seconds in the microhardness test, so that the test piece is subjected to creep.

A relationship between the amount x of plastic deformation obtained in the microhardness test and the evaluation items for the compound lens 10 is shown in Table 3. The unit of the amount x of plastic deformation is “m (micrometer)”. The amounts x of plastic deformation in cases where the material of the resin is set to be different are measured in the microhardness test. The amount x of plastic deformation is defined as the amount of deformation remaining after the test piece is subjected to creep by holding a state where a load is removed for 5 seconds. The number of tests to be performed for each material is 10, and the amount x of plastic deformation is calculated as an average value of numerical values obtained in the respective tests. Examples of the evaluation items for the compound lens 10 include “quality of coating”, “environmental resistance”, and “suction resistance”.

The “quality of coating” is evaluated as “excellent”, “good”, or “unacceptable” in terms of the quality of a coating of the first lens 12 in a case where an anti-reflection (AR) coating is formed on the first lens 12. The AR coating refers to an anti-reflective multilayer film formed on the concave surface 18 of the first lens 12. The AR coating is formed using, for example, vapor deposition. A fact that the “quality of coating” is “excellent” indicates that the concave surface 18 on which the AR coating is formed is not deformed and the quality of the coating can be ensured. A fact that the “quality of coating” is “good” indicates that the concave surface 18 is deformed but the amount of deformation of the concave surface 18 is within an allowable range and the coating quality can be ensured. A fact that the “quality of coating” is “unacceptable” indicates that the amount of deformation of the concave surface 18 is out of the allowable range and the quality of the coating is insufficient.

The “environmental resistance” is evaluated as “excellent”, “good”, or “unacceptable” in terms of durability in a case where the compound lens 10 is placed in a low temperature environment. A fact that the “environmental resistance” is “excellent” indicates that the cracks 44 do not occur and the breakage of the second lens 14 can be prevented even in a case where the compound lens 10 is placed in a low temperature environment. A fact that the “environmental resistance” is “good” indicates that the cracks 44 occur in a case where the compound lens 10 is placed in a low temperature environment but the number and/or size of the cracks 44 is within an allowable range and the breakage of the second lens 14 can be prevented. A fact that the “environmental resistance” is “unacceptable” indicates that the number and/or size of the cracks 44 occurring in a case where the compound lens 10 is placed in a low temperature environment is out of the allowable range and the second lens 14 is broken.

The “suction resistance” is evaluated as “excellent”, “good”, or “unacceptable” in terms of scratches occurring on the concave surface 18 in a case where the concave surface 18 of the first lens 12 is sucked by a suction pad or the like for the transport of the compound lens 10. A fact that the “suction resistance” is “excellent” indicates that the concave surface 18 is not deformed even in a case where the concave surface 18 of the first lens 12 is sucked by a suction pad or the like and the quality of the first lens 12 can be ensured. A fact that the “suction resistance” is “good” indicates that the concave surface 18 is deformed in a case where the concave surface 18 of the first lens 12 is sucked by a suction pad or the like, but the amount of deformation of the concave surface 18 is within an allowable range and the quality of the first lens can be ensured. A fact that the “suction resistance” is “unacceptable” indicates that the amount of deformation of the concave surface 18 in a case where the concave surface 18 of the first lens 12 is sucked by a suction pad or the like is out of the allowable range and the quality of the first lens 12 is insufficient.

TABLE 3

| | | | | Environ- | |
|---|---|---|---|---|---|
| | | x | Quality of | mental | Suction |
| | | [mm] | coating | resistance | resistance |
| 1 | Example | 1 | Excellent | Good | Excellent |
| 2 | Example | 3 | Excellent | Excellent | Excellent |
| 3 | Example | 4 | Good | Excellent | Good |
| 4 | Comparative | 4.1 | Good | Excellent | Unaccept- |
| | Example | | | | able |
| 5 | Comparative | 4.2 | Good | Excellent | Unaccept- |
| | Example | | | | able |
| 6 | Comparative | 4.5 | Unaccept- | Excellent | Unaccept- |
| | Example | | able | | able |
| 7 | Comparative | 5 | Unaccept- | Excellent | Unaccept- |
| | Example | | able | | able |
| 8 | Comparative | 6 | Unaccept- | Excellent | Unaccept- |
| | Example | | able | | able |
| 9 | Comparative | 0.9 | Excellent | Unaccept- | Excellent |
| | Example | | | able | |
| 10 | Comparative | 0.8 | Excellent | Unaccept- | Excellent |
| | Example | | | able | |
| 11 | Comparative | 0.5 | Excellent | Unaccept- | Excellent |
| | Example | | | able | |

From results of the microhardness test shown in Table 3, it is preferable that the resin satisfies Conditional Expression (13) to be described below.

$$1. μm \leq x \leq 4. μm \qquad ( 13 )$$

In a case where the amount x of plastic deformation is less than 1.0 μm in Conditional Expression (13), the second lens 14 is broken due to the occurrence of the cracks 44. In a case where the amount x of plastic deformation is 1.0 μm or more in Conditional Expression (13), the breakage of the second lens 14 can be prevented since the occurrence of the cracks 44 is suppressed. In a case where the amount x of plastic deformation exceeds 4.0 μm in Conditional Expression (13) and the concave surface 18 of the first lens 12 is sucked by a suction pad or the like, the quality of the first lens 12 is insufficient due to the deformation of the concave surface 18. In a case where the amount x of plastic deformation is 4.5 μm or more in Conditional Expression (13) and the AR coating is formed on the first lens 12, the quality of the first lens 12 is insufficient due to the deformation of the concave surface 18. In a case where the amount x of plastic deformation is 4.0 μm or less in Conditional Expression (13), the deformation of the concave surface 18 is prevented even though the concave surface 18 of the first lens 12 is sucked by a suction pad or the like, and the deformation of the concave surface 18 is prevented even though the AR coating is formed on the first lens 12. Accordingly, the quality of the first lens can be ensured.

It is preferable that the hardness of the resin at a temperature of 25° C. is 186 MPa or more and 196 MPa or less. In a case where the hardness of the resin at a temperature of 25° C. is less than 186 MPa and the concave surface 18 of the first lens 12 is sucked by a suction pad or the like, scratches occur on the concave surface 18. In a case where the hardness of the resin at a temperature of 25° C. is 186 MPa or more, the occurrence of scratches on the concave surface 18 can be prevented even though the concave surface 18 of the first lens 12 is sucked by a suction pad or the like. In a case where the hardness of the resin at a temperature of 25° C. exceeds 196 MPa, the second lens 14 is broken by a physical force generated due to the deformation of the first lens 12 in a low temperature environment or the like. In a case where the hardness of the resin at a temperature of 25° C. is 196 MPa or less, the breakage of the second lens 14 can be prevented even in a low temperature environment or the like.

Further, it is preferable that the hardness of the resin at a temperature of 75° C. is 149 MPa or more and 164 MPa or less. The temperature of 75° C. is a temperature assumed in a case where the AR coating or the like is formed on the concave surface 18 of the first lens 12. In a case where the hardness of the resin at a temperature of 75° C. is less than 149 MPa and the AR coating is formed on the first lens 12, the concave surface 18 is deformed. In a case where the hardness of the resin at a temperature of 75° C. is 149 MPa or more, the deformation of the concave surface 18 can be prevented even though the AR coating is formed on the first lens 12. In a case where the hardness of the resin at a temperature of 75° C. exceeds 164 MPa, the second lens 14 is broken by a physical force that is generated due to the deformation of the first lens 12 in a case where the AR coating or the like is formed on the concave surface 18 of the first lens 12. In a case where the hardness of the resin at a temperature of 75° C. is 164 MPa or less, the breakage of the second lens 14 caused by a physical force generated due to the deformation of the first lens 12 can be prevented even though the AR coating or the like is formed on the concave surface 18 of the first lens 12.

Furthermore, it is preferable that the elastic recovery ratio of the resin at a temperature of 75° C. is 59% or more and 63% or less. In a case where the elastic recovery ratio of the resin at a temperature of 75° C. is less than 59% and the concave surface 18 of the first lens 12 is sucked by a suction pad or the like, scratches occur on the concave surface 18. In a case where the elastic recovery ratio of the resin at a temperature of 75° C. is 59% or more, the occurrence of scratches on the concave surface 18 can be prevented even though the concave surface 18 of the first lens 12 is sucked by a suction pad or the like. In a case where the elastic recovery ratio of the resin at a temperature of 75° C. exceeds 63%, the second lens 14 is broken due to the occurrence of the cracks 44. In a case where the elastic recovery ratio of the resin at a temperature of 75° C. is 63% or less, the breakage of the second lens 14 can be prevented since the occurrence of the cracks 44 is suppressed.

In addition, it is preferable that the indentation elastic modulus of the resin at a temperature of 25° C. is 3.5 GPa or more and 3.6 GPa or less. In a case where the indentation elastic modulus of the resin at a temperature of 25° C. is less than 3.5 GPa and the AR coating is formed on the first lens 12, the concave surface 18 is deformed. In a case where the indentation elastic modulus of the resin at a temperature of 25° C. is 3.5 GPa or more, the deformation of the concave surface 18 can be prevented even though the AR coating is formed on the first lens 12. In a case where the indentation elastic modulus of the resin at a temperature of 25° C. exceeds 3.6 GPa, the second lens 14 is broken by a physical force that is generated due to the deformation of the first lens 12 in a low temperature environment or the like. In a case where the indentation elastic modulus of the resin at a temperature of 25° C. is 3.6 GPa or less, the breakage of the second lens 14 can be prevented even in a low temperature environment or the like.

Further, it is preferable that the indentation elastic modulus of the resin at a temperature of 75° C. is 2.2 GPa or more and 2.4 GPa or less. In a case where the indentation elastic modulus of the resin at a temperature of 75° C. exceeds 2.4 GPa, the second lens 14 is broken by a physical force that is generated due to the deformation of the first lens 12 caused by thermal expansion. In a case where the indentation elastic modulus of the resin at a temperature of 75° C. is 2.4 GPa or less, the breakage of the second lens 14 can be prevented even though the first lens 12 is deformed due to thermal expansion.

### (Configuration of Imaging Lens Including Compound Lens 10)

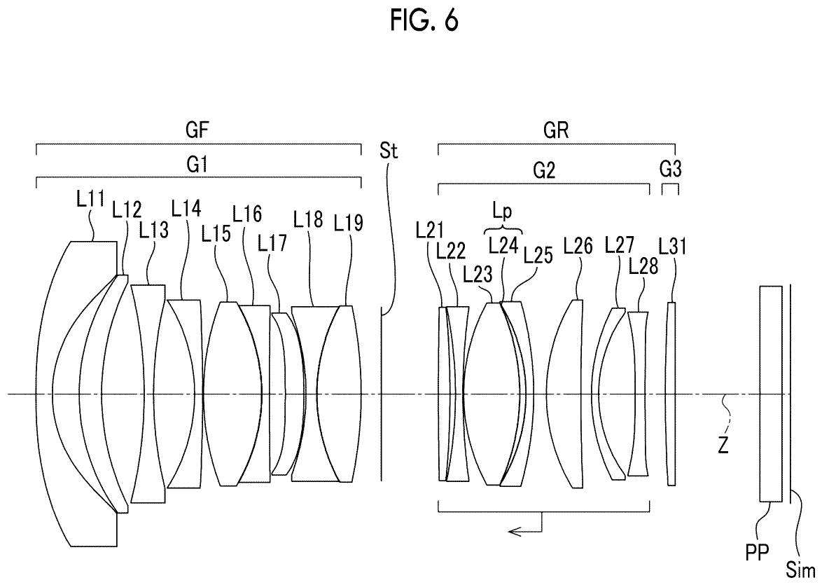

Subsequently, an example of an imaging lens including the compound lens 10 will be described. For example, a state where an imaging lens according to an embodiment of the present disclosure is focused on an infinite distance object is shown in FIG. 6. The imaging lens is an example of an “optical system” according to the technique of the present disclosure. In the present specification, an object at an infinite distance is referred to as an infinite distance object and an object at a close distance is referred to as a close object. In the example shown in FIG. 6, a left side is an object side and a right side is an image side.

For example, an example in which an optical member PP having a parallel flat plate shape is disposed between the imaging lens and an image plane Sim on the assumption that the imaging lens is applied to an imaging apparatus is shown in FIG. 6. The optical member PP is a member that is assumed to include various filters, a cover glass, and/or the like. The various filters include a low-pass filter, an infrared cut filter, a filter for cutting a specific wavelength range, and/or the like. The optical member PP is a member that does not have an optical power. The imaging lens can also be configured without the optical member PP.

The imaging lens includes a front group GF, an aperture stop St, and a rear group GR. The front group GF, the aperture stop St, and the rear group GR are arranged in this order from the object side to the image side along an optical axis Z. According to this configuration, it is advantageous in suppressing various aberrations while maintaining a small size and a small weight.

For example, the front group GF and the rear group GR of the imaging lens are configured as follows. The front group GF includes a first lens group G1. The first lens group G1 includes nine lenses L11 to L19 arranged in order from the object side to the image side. The rear group GR includes a second lens group G2 and a third lens group G3 arranged in order from the object side to the image side. The second lens group G2 includes eight lenses L21 to L28. The third lens group G3 includes one lens L31.

In the example shown in FIG. 6, during focusing, the first lens group G1 and the third lens group G3 are stationary with respect to the image plane Sim and the entire second lens group moves along the optical axis Z as one body. The term “moves as one body” mentioned herein means that objects move at the same time by the same distance in the same direction. In the present specification, a group that moves along the optical axis Z during focusing is referred to as a focus group. Focusing is performed through the movement of the focus group. A left arrow under the second lens group G2 shown in FIG. 6 indicates that the second lens group G2 is a focus group moving toward the object side during the focusing of the imaging lens on a close object from the infinite distance object.

In the present specification, the term “lens group” refers to a component of the imaging lens that includes at least one lens divided by an air gap changing during focusing. During focusing, each lens group moves or is stationary and an interval between the lenses included in each lens group does not change. That is, in the present specification, a group of which intervals with adjacent groups change and in which all intervals between adjacent lenses therein do not change during focusing is referred to as one lens group.

The rear group GR of the imaging lens includes at least one Lp lens Lp that is made of a resin, has a positive optical power, and is cemented to a lens. Since the above-mentioned Lp lens Lp made of a resin as a material is disposed in the rear group GR, it is easy to correct axial chromatic aberration and lateral chromatic aberration in a balanced manner while achieving a reduction in weight. In the example shown in FIG. 6, the lens L24 corresponds to the Lp lens Lp. The lens L24 of the example shown in FIG. 6 is cemented to the lens L23 and the lens L25. A surface of the Lp lens facing the image side corresponds to a convex surface, and a surface of the Lp lens facing the object side corresponds to a concave surface.

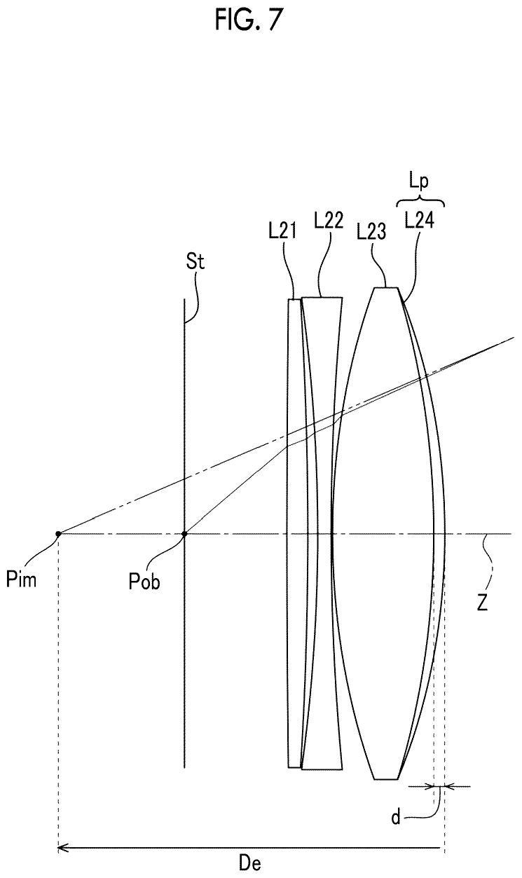

It is preferable that the Lp lens Lp satisfies Conditional Expression (14) to be described below. Here, a central thickness of the Lp lens Lp is denoted by d, a curvature radius of the surface of the Lp lens facing the object side is denoted by Rf, and a curvature radius of the surface of the Lp lens facing the image side is denoted by Rr. For example, an enlarged view of a portion, which includes the Lp lens Lp, of the imaging lens shown in FIG. 6 is shown in FIG. 7. The Lp lens Lp satisfying Conditional Expression (14) has a shape in which d is small and Rf and Rr are close to each other. In a case where a corresponding value of Conditional Expression (14) is made to be larger than a lower limit, it is possible to increase the optical power of the Lp lens Lp. Accordingly, it is possible to obtain a higher effect of correcting chromatic aberration. In a case where the corresponding value of Conditional Expression (14) is made to be smaller than an upper limit, the optical power and thickness of the Lp lens Lp can be appropriately set. Accordingly, it is easy to suppress fluctuations in aberration in a case where a refractive index of the Lp lens Lp fluctuates due to a change in environment such as a temperature. In order to obtain better characteristics, it is more preferable that the Lp lens Lp satisfies Conditional Expression (14-1) to be described below, it is even more preferable that the Lp lens Lp satisfies Conditional Expression (14-2) to be described below, and it is still more preferable that the Lp lens Lp satisfies Conditional Expression (14-3) to be described below.

$$0 < d \times ( 1 / Rf - 1 / Rr ) < 0.05 \qquad ( 14 )$$

$$0.0001 < d \times ( 1 / Rf - 1 / Rr ) < 0.025 \qquad ( 14 - 1 )$$

$$0.0005 < d \times ( 1 / Rf - 1 / Rr ) < 0.015 \qquad ( 14 - 2 )$$

$$0.0013 < d \times ( 1 / Rf - 1 / Rr ) < 0.009 \qquad ( 14 - 3 )$$

It is preferable that the imaging lens satisfies Conditional Expression (15) to be described below. Here, a sum of a distance on the optical axis between a lens surface of the front group GF closest to the object side and a lens surface of the rear group GR closest to the image side and an air conversion distance on the optical axis between the lens surface of the rear group GR closest to the image side and the image plane Sim in a state where the imaging lens is focused on the infinite distance object is denoted by TL and a focal length of the Lp lens Lp is denoted by fp. fp is calculated on the assumption that a medium on each of the object side and the image side of the Lp lens Lp is air. In a case where a corresponding value of Conditional Expression (15) is made to be larger than a lower limit, it is possible to enhance an effect of correcting the chromatic aberration of the Lp lens Lp. In a case where the corresponding value of Conditional Expression (15) is made to be smaller than an upper limit, it is possible to suppress fluctuations in aberration in a case where the refractive index of the Lp lens Lp fluctuates due to a change in environment such as a temperature. In order to obtain better characteristics, it is more preferable that the imaging lens satisfies Conditional Expression (15-1) to be described below and it is even more preferable that the imaging lens satisfies Conditional Expression (15-2) to be described below.

$$0.1 < TL / fp < 1.2 \qquad ( 15 )$$

$$0.15 < TL / fp < 0.95 \qquad ( 15 - 1 )$$

$$0.25 < TL / fp < 0.61 \qquad ( 15 - 2 )$$

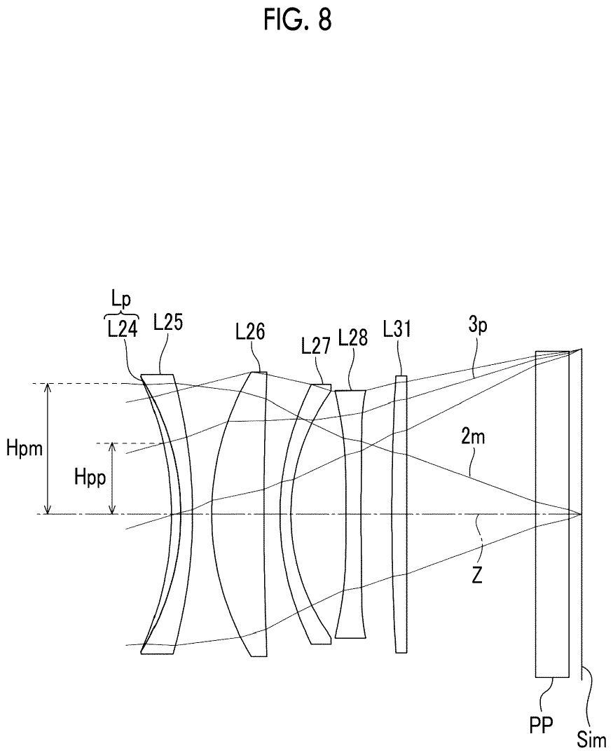

It is preferable that the imaging lens satisfies Conditional Expression (16) to be described below. Here, a height of a principal ray 3p, which has a maximum half angle om of view, from the optical axis Z on the surface of the Lp lens Lp facing the object side in a state where the imaging lens is focused on the infinite distance object is denoted by Hpp. Further, a height of an axial marginal ray 2m from the optical axis Z on the surface of the Lp lens Lp facing the object side in a state where the imaging lens is focused on the infinite distance object is denoted by Hpm. For example, the height Hpp and the height Hpm in the imaging lens shown in FIG. 6 are shown in FIG. 8. A range from the lens L24 corresponding to the Lp lens Lp to the image plane Sim is enlarged and shown in FIG. 8 together with the respective rays. In a case where a corresponding value of Conditional Expression (16) is made to be larger than a lower limit, it is advantageous in correcting lateral chromatic aberration. In a case where the corresponding value of Conditional Expression (16) is made to be smaller than an upper limit, it is advantageous in correcting axial chromatic aberration. In order to obtain better characteristics, it is more preferable that the imaging lens satisfies Conditional Expression (16-1) to be described below and it is even more preferable that the imaging lens satisfies Conditional Expression (16-2) to be described below.

$$0.2 < Hpp / Hpm < 1.1 \qquad ( 16 )$$

$$0.31 < Hpp / Hpm < 0.9 \qquad ( 16 - 1 )$$

$$0.5 < Hpp / Hpm < 0.72 \qquad ( 16 - 2 )$$

It is preferable that the imaging lens satisfies Conditional Expression (17) to be described below. Here, in a case where a point present at a position of the aperture stop St on the optical axis is set as an object point in a state where the imaging lens is focused on the infinite distance object, a distance on the optical axis between an image point, which is formed by an optical system ranging from a lens surface adjacent to the image side of the aperture stop St to the surface of the Lp lens Lp facing the image side, and the surface of the Lp lens Lp facing the image side is denoted by De. For example, the distance De in the imaging lens shown in FIG. 6 is shown in FIG. 7. Here, De is calculated on the assumption that a medium closer to the image side than the surface of the Lp lens Lp facing the image side is air. The sign of De is set to be negative in a case where the image point is closer to the object side than the surface of the Lp lens Lp facing the image side on the optical axis, and is set to be positive in a case where the image point is closer to the image side than the surface of the Lp lens Lp facing the image side. In a case where a corresponding value of Conditional Expression (17) is made to be larger than a lower limit, it is advantageous in correcting lateral chromatic aberration. In a case where the corresponding value of Conditional Expression (17) is made to be smaller than an upper limit, it is advantageous in achieving a reduction in size. In order to obtain better characteristics, it is more preferable that the imaging lens satisfies Conditional Expression (17-1) to be described below and it is even more preferable that the imaging lens satisfies Conditional Expression (17-2) to be described below.

$$- 0.9 < ( De - Rr ) / ( De + Rr ) < 0.9 \qquad ( 17 )$$

$$- 0.7 < ( De - Rr ) / ( De + Rr ) < 0.5 \qquad ( 17 - 1 )$$

$$- 0.56 < ( De - Rr ) / ( De + Rr ) < 0.16 \qquad ( 17 - 2 )$$

In a case where a focal length of a focus group moving along the optical axis Z during focusing is denoted by ffoc, it is preferable that the imaging lens satisfies Conditional Expression (18) to be described below. In a case where a corresponding value of Conditional Expression (18) is made to be larger than a lower limit, it is advantageous in suppressing fluctuations in chromatic aberration during focusing. In a case where the corresponding value of Conditional Expression (18) is made to be smaller than an upper limit, it is possible to suppress fluctuations in aberration in a case where the refractive index of the Lp lens Lp fluctuates due to a change in environment such as a temperature. In order to obtain better characteristics, it is more preferable that the imaging lens satisfies Conditional Expression (18-1) to be described below and it is even more preferable that the imaging lens satisfies Conditional Expression (18-2) to be described below.

$$0.04 < ffoc / fp < 0.36 \qquad ( 18 )$$

$$0.065 < ffoc / fp < 0.28 \qquad ( 18 - 1 )$$

$$0.094 < ffoc / fp < 0.22 \qquad ( 18 - 2 )$$

In a case where a maximum angle of view in a state where the imaging lens is focused on the infinite distance object is denoted by om and the imaging lens satisfies Conditional Expression (19) to be described below, it is preferable that the rear group GR includes the Lp lens Lp. The unit of the maximum angle om of view is “° (degree)”. In a case where a corresponding value of Conditional Expression (19) is made to be equal to or larger than a lower limit, it is possible to obtain good optical performance.

$$ω m \geq 45 ° \qquad ( 19 )$$

On the other hand, in a case where the imaging lens satisfies Conditional Expression (20) to be described below, it is preferable that the front group GF includes an Lp lens Lp. Even in a case where a corresponding value of Conditional Expression (20) is made to be smaller than a upper limit, it is possible to obtain good optical performance.

$$ω m < 45 ° \qquad ( 20 )$$

In a case where a central thickness of the Lp lens Lp is denoted by A, a thickness of the compound lens in the optical axis direction at a maximum effective diameter height on both surfaces of the Lp lens Lp is denoted by B, a maximum image height is denoted by Y, a partial dispersion ratio of the Lp lens between a g line and an F line is denoted by θgF, an Abbe number of the Lp lens with respect to a d line is denoted by νd, and ΔθgF is represented by Conditional Expression (21), it is preferable that the imaging lens satisfies Conditional Expression (22). In a case where a corresponding value of Conditional Expression (22) is made to be larger than a lower limit, it is possible to obtain a higher effect of correcting chromatic aberration. In a case where the corresponding value of Conditional Expression (22) is made to be smaller than an upper limit, it is possible to suppress a difference in deformation between a center portion and a peripheral portion of the Lp lens Lp even though a temperature changes.

$$Δ θ gF = θ gF - ( 0.6438 - 0.001682 \times vd ) \qquad ( 21 )$$

$$0.004 < ( \vert A - B \vert Δ θ gF ) / Y < 0.02 \qquad ( 22 )$$

It is more preferable that (|A−B|ΔθgF)/Y is greater than 0.006 and less than 0.014. It is even more preferable that (|A−B|ΔθgF)/Y is greater than 0.008 and less than 0.012.

In the imaging lens, the compound lens 10 may be included in the front group GF and the second lens 14 may be disposed closer to the object side than the first lens 12. Further, in the imaging lens, the compound lens 10 may be included in the rear group GR and the second lens 14 may be disposed closer to the image side than the first lens 12.

Next, Examples of the imaging lens according to the embodiment of the present disclosure will be described with reference to the drawings. Reference numerals given to lenses in a cross-sectional view of each example are used independently for each example in order to avoid the complication of description and drawings caused by an increase in the number of digits of the reference numerals. Accordingly, even though common reference numerals are given to components in the drawings of different examples, the components are not necessarily common.

### Example 1

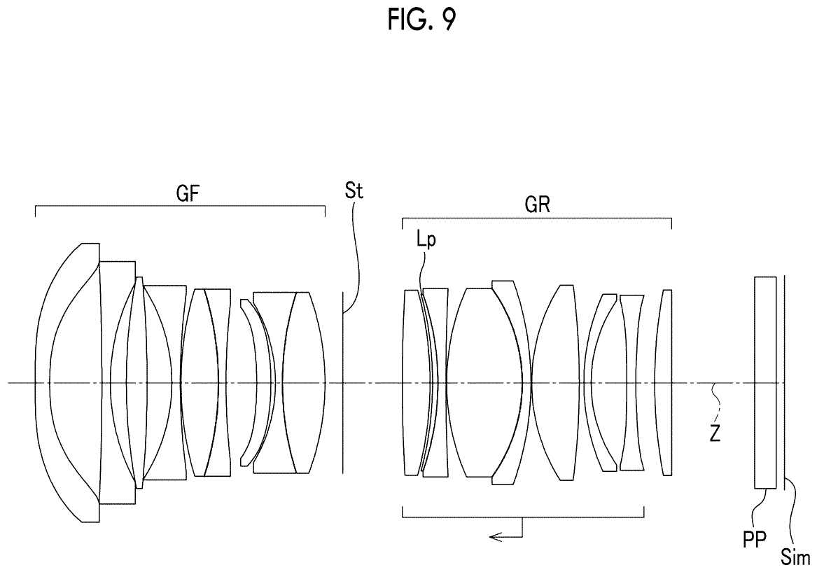

FIG. 9 is a cross-sectional view showing a configuration of an imaging lens according to Example 1. The imaging lens according to Example 1 includes a first lens group having a positive optical power, an aperture stop St, a second lens group having a positive optical power, and a third lens group having a positive optical power that are arranged in order from an object side to an image side. A front group GF includes the first lens group. A rear group GR includes the second lens group and the third lens group. In a case where the imaging lens is focused on a close object from an infinite distance object, the first lens group and the third lens group are stationary with respect to an image plane Sim and the second lens group moves toward the object side.

An Lp lens Lp is included in a second lens component of the second lens group from the object side. This lens component is a cemented lens in which the Lp lens Lp and a negative lens arranged in order from the object side are cemented to each other.

With regard to the imaging lens of Example 1, Table 4 shows basic lens data, Table 5 shows specifications and variable surface spacings, and Table 6 shows aspherical coefficients. The table showing the basic lens data is described as follows. An Sn column shows surface numbers in a case where a surface closest to the object side is defined as a first surface and a number is increased one by one toward the image side. An R column shows a curvature radius of each surface. A D column shows a surface spacing on an optical axis between each surface and a surface that is positioned on the image side thereof and is adjacent to the surface.

An Nd column shows a refractive index of each component with respect to the d line. A νd column shows an Abbe number of each component with respect to the d line. A cell of a lens corresponding to the Lp lens Lp in a θgF column shows a partial dispersion ratio of the lens between the g line and the F line. A twenty third surface and a twenty fourth surface of Table 4 correspond to the Lp lens Lp.

In the table showing the basic lens data, the sign of a curvature radius of a surface convex toward the object side is set to be positive and the sign of a curvature radius of a surface convex toward the image side is set to be negative. A surface number and a text of (St) are written in a cell of a surface number of a surface corresponding to the aperture stop St. A value at the bottom cell of the column of a surface spacing in the table indicates a spacing between the image plane Sim and the surface closest to the image side in the table. A symbol DD[ ] is used for the variable surface spacing during focusing. A surface number on the object side of the spacing is provided inside [ ] and is written in the column of the surface spacing.

“° (degree)” is used as the unit of an angle and “mm (millimeter)” is used as the unit of a length in the data of the respective tables, but other appropriate units can also be used since the optical system can be used even though being proportionally increased or reduced in size. Further, numerical values, which are rounded off to a predetermined place, are written in each table to be described below.

TABLE 4

| Sn | R | D | Nd | νd | θgF |
|---|---|---|---|---|---|
| *1 | 132605.6161 | 1.8978 | 1.51633 | 64.06 | |
| *2 | 35.3775 | 6.9512 | | | |
| 3 | −339.2187 | 1.1078 | 1.81386 | 24.31 | |
| 4 | 28.0748 | 2.1226 | | | |
| 5 | 73.8138 | 2.7658 | 1.95001 | 33.00 | |
| 6 | −151.5488 | 3.2681 | | | |
| 7 | −23.6369 | 1.1287 | 1.43999 | 81.27 | |
| 8 | 88.4721 | 0.1000 | | | |
| 9 | 43.1017 | 4.9631 | 1.93685 | 34.32 | |
| 10 | −41.6262 | 1.0007 | 1.63717 | 37.90 | |
| 11 | 95.2786 | 4.0634 | | | |
| *12 | −50.8618 | 1.8877 | 1.80621 | 40.91 | |
| *13 | −34.7920 | 0.6058 | | | |
| 14 | −20.6656 | 0.9258 | 1.51774 | 52.50 | |
| 15 | 39.5975 | 5.6590 | 1.84527 | 43.32 | |
| 16 | −34.4028 | 2.3376 | | | |
| 17(St) | ∞ | DD[17] | | | |
| 18 | 214.8808 | 3.6191 | 1.51012 | 78.44 | |
| 19 | −46.7907 | 0.3406 | | | |
| 20 | −45.4102 | 0.7000 | 1.59833 | 20.31 | 0.83392 |
| 21 | −35.7016 | 1.0710 | 1.79212 | 26.99 | |
| 22 | 286.1184 | 0.1000 | | | |
| 23 | 30.9146 | 10.0209 | 1.45773 | 86.50 | |
| 24 | −21.4709 | 1.1545 | 1.74256 | 32.03 | |
| 25 | −39.6826 | 0.1000 | | | |
| 26 | 24.0375 | 6.3139 | 1.57736 | 68.10 | |
| 27 | −103.1153 | 0.6084 | | | |
| 28 | 28.6708 | 0.9613 | 1.59738 | 39.14 | |
| 29 | 19.2265 | 4.7112 | | | |
| *30 | −241422.1816 | 1.2176 | 1.79103 | 42.12 | |
| *31 | 66.3335 | DD[31] | | | |
| 32 | 65.1634 | 2.2616 | 1.54506 | 73.07 | |
| 33 | −38590.3182 | 11.0211 | | | |
| 34 | ∞ | 2.8500 | 1.51680 | 64.20 | |
| 35 | ∞ | 1.1000 | | | |

TABLE 5

| | | Close distance |
|---|---|---|
| | Infinite distance | 97 mm |
| Focal length | 18.12 | 18.53 |
| Open F number | 1.46 | 1.60 |
| Maximum total angle of view | 76.2 | 72.0 |
| [°] | | |
| DD[17] | 7.9128 | 4.0044 |
| DD[31] | 2.5000 | 6.4084 |

TABLE 6

| Sn | 1 | 2 | 12 |
|---|---|---|---|
| KA | −4.9999975823E+00 | 9.0564499476E−01 | 2.5371050465E+00 |
| A3 | 0.0000000000E+00 | 0.0000000000E+00 | 0.0000000000E+00 |
| A4 | 1.8214983670E−04 | 1.8388965999E−04 | −6.5211177486E−05 |
| A5 | −3.4244624298E−06 | −1.8762601085E−06 | 1.3633242991E−06 |
| A6 | −1.2301757446E−06 | −1.2385930540E−06 | −1.2299846544E−06 |
| A7 | 2.9432370541E−08 | 5.6831868528E−08 | 2.0556710164E−07 |
| A8 | 8.3614322746E−09 | −6.0521473761E−09 | −1.6366710547E−08 |
| A9 | −3.9140250344E−10 | 1.3062411976E−09 | −1.2029432851E−09 |
| A10 | −2.1962871606E−11 | −6.4939571064E−11 | 3.3217765134E−10 |
| A11 | 1.3915091110E−12 | −2.4154579269E−12 | −2.7986191823E−11 |
| A12 | 5.6937541161E−14 | 2.9965861021E−13 | 8.7546237963E−13 |
| A13 | −5.6566615280E−15 | −2.4642394464E−14 | 7.8541685018E−14 |
| A14 | 1.0205912739E−16 | 2.4876232625E−15 | −1.5015800142E−14 |
| A15 | 1.6343011697E−18 | −1.2497757724E−16 | 9.7849756602E−16 |
| A16 | −5.0315251508E−20 | 2.1603907341E−18 | −2.2520121427E−17 |
| Sn | 13 | 30 | 31 |
| KA | 2.7612794169E+00 | −4.9999923706E+00 | −1.2578112734E+00 |
| A3 | 0.0000000000E+00 | 0.0000000000E+00 | 0.0000000000E+00 |
| A4 | −4.4375078142E−05 | −6.2769511042E−05 | −4.3420069731E−07 |
| A5 | 1.0292208120E−06 | −1.6084967699E−05 | −3.1030626290E−05 |
| A6 | −1.2628959508E−06 | −2.3976158449E−07 | 7.5495741509E−06 |
| A7 | 3.5587774346E−07 | 2.0472115339E−06 | −6.5947958849E−07 |
| A8 | −5.7267643913E−08 | −6.6393294070E−07 | −1.2024285236E−08 |
| A9 | 1.9176178614E−09 | 1.1485550600E−07 | 8.1095245052E−09 |
| A10 | 7.4597799195E−10 | −1.3010334758E−08 | −7.6871341504E−10 |
| A11 | −1.0708694061E−10 | 1.1529399919E−09 | 5.7207680308E−11 |
| A12 | 1.6123113957E−12 | −9.8355998392E−11 | −5.6441254551E−12 |
| A13 | 8.4723078464E−13 | 8.0210706727E−12 | 3.8115245910E−13 |
| A14 | −9.0398540898E−14 | −4.9610049476E−13 | −9.8936689597E−15 |
| A15 | 4.0294842301E−15 | 1.8489150694E−14 | −1.0082645116E−16 |
| A16 | −7.1250896502E−17 | −3.0203642417E−16 | 6.5247839855E−18 |

### Example 2

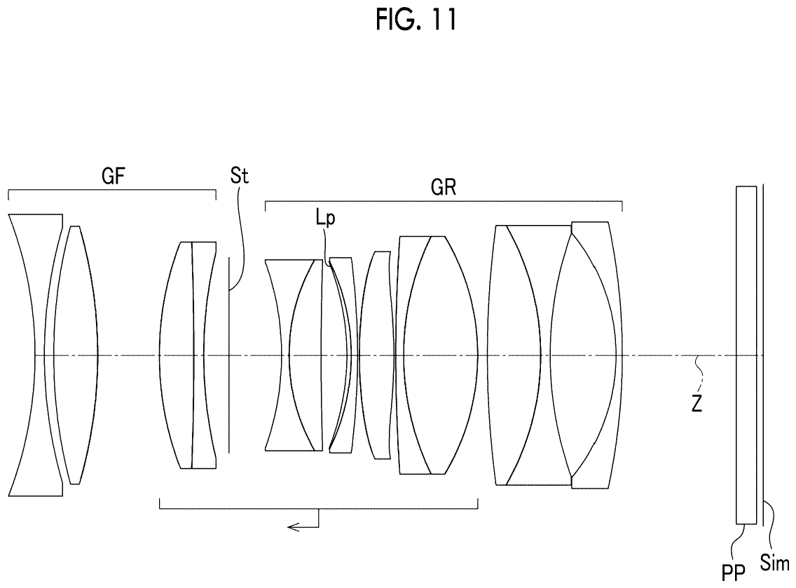

FIG. 11 is a cross-sectional view showing a configuration of an imaging lens of Example 2. The imaging lens of Example 2 includes a first lens group having a negative optical power, a second lens group having a positive optical power, and a third lens group having a negative optical power that are arranged in order from an object side to an image side. The second lens group includes an aperture stop St. A front group GF includes the first lens group and a part of the second lens group close to the object side. A rear group GR includes the other part of the second lens group and the third lens group. In a case where the imaging lens is focused on a close object from an infinite distance object, the first lens group and the third lens group are stationary with respect to an image plane Sim and the second lens group moves toward the object side.

An Lp lens Lp is included in a second lens component of the second lens group from the object side. This lens component is a cemented lens in which the Lp lens Lp and a negative lens arranged in order from the object side are cemented to each other.

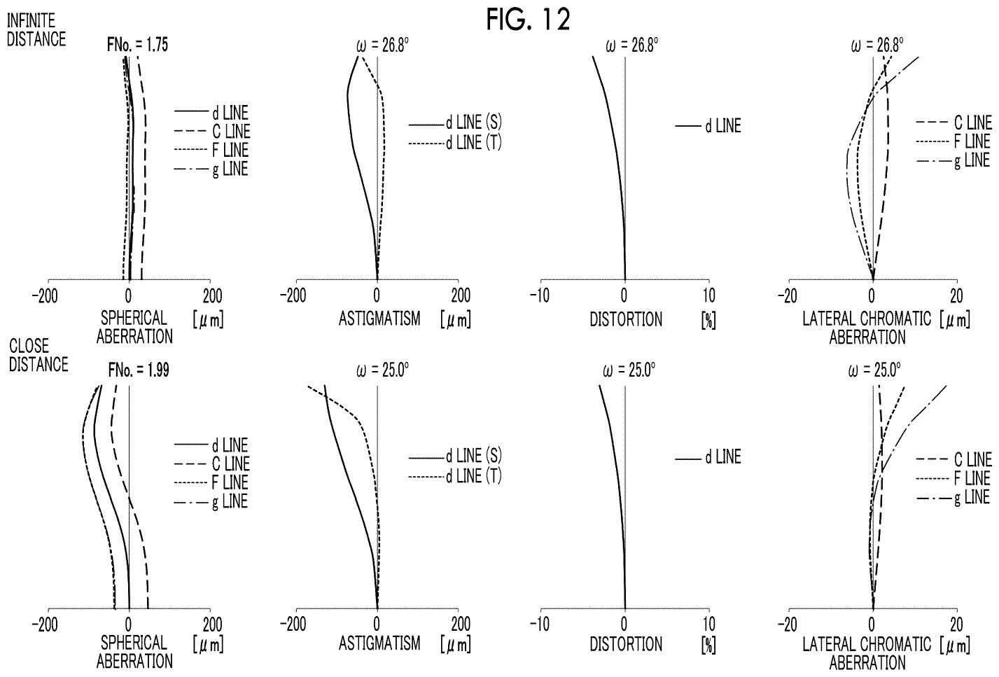

With regard to the imaging lens of Example 2, Table 7 shows basic lens data, Table 8 shows specifications and variable surface spacings, Table 9 shows aspherical coefficients, and FIG. 12 is a diagram showing the respective aberrations. Twelfth to thirteenth surfaces of Table 7 correspond to the Lp lens Lp.

TABLE 7

| Sn | R | D | Nd | νd | θgF |
|---|---|---|---|---|---|
| 1 | −61.9356 | 1.5000 | 1.51742 | 52.43 | |
| 2 | 73.4976 | 1.5000 | | | |
| *3 | 85.9038 | 7.0001 | 1.58313 | 59.46 | |
| *4 | −73.9171 | DD[4] | | | |
| 5 | 50.3273 | 5.5000 | 1.85150 | 40.78 | |
| 6 | −494.8646 | 1.5100 | 1.59551 | 39.24 | |
| 7 | 70.5210 | 4.0000 | | | |
| 8(St) | ∞ | 8.4049 | | | |
| 9 | −43.7729 | 1.2100 | 1.59551 | 39.24 | |
| 10 | 30.5775 | 5.0973 | 1.75500 | 52.32 | |
| 11 | 446.3743 | 4.1107 | | | |
| *12 | −39.6052 | 0.7000 | 1.59833 | 20.31 | 0.83435 |
| 13 | −34.2307 | 1.0000 | 1.59551 | 39.24 | |
| 14 | −122.8152 | 0.3000 | | | |
| *15 | 71.7128 | 5.5000 | 1.69350 | 53.20 | |
| *16 | −75.0791 | 0.3002 | | | |
| 17 | 272.6236 | 1.2700 | 1.59551 | 39.24 | |
| 18 | 43.5277 | 11.8057 | 1.49700 | 81.54 | |
| 19 | −36.7266 | DD[19] | | | |
| 20 | 158.8561 | 8.5014 | 1.88300 | 40.76 | |
| 21 | −41.7059 | 1.5202 | 1.59551 | 39.24 | |
| 22 | 57.9998 | 10.4174 | | | |
| 23 | −30.8126 | 1.0001 | 1.48749 | 70.24 | |
| 24 | −101.9347 | 18.1847 | | | |
| 25 | ∞ | 3.2000 | 1.51680 | 64.20 | |
| 26 | ∞ | 1.1000 | | | |

TABLE 8

| | | Close distance |
|---|---|---|
| | Infinite distance | 300 mm |
| Focal length | 56.43 | 52.84 |
| Open F number | 1.75 | 1.99 |
| Maximum total angle of view | 53.5 | 50.0 |
| [°] | | |
| DD[4] | 9.8374 | 2.1427 |
| DD[19] | 1.5448 | 9.2394 |

TABLE 9

| Sn | 3 | 4 | 12 |
|---|---|---|---|
| KA | 1.0000000000E+00 | 1.0000000000E+00 | 1.0000000000E+00 |
| A4 | 8.6904290127E−07 | 5.9860796378E−08 | 1.1308276598E−06 |
| A6 | −1.1987878195E−10 | −7.2246335077E−10 | −2.6508000748E−09 |
| A8 | 3.5992754959E−12 | 5.5888485740E−12 | 3.2224981708E−11 |
| A10 | −1.8012445782E−14 | −1.6756476564E−14 | −3.1159637629E−14 |
| A12 | 7.9205331672E−17 | 2.6863603430E−17 | −1.9559123272E−16 |
| A14 | −2.1161023857E−19 | −4.0164086941E−20 | −4.0528177081E−19 |
| A16 | 5.5185491788E−23 | −6.4360277265E−24 | 2.9581367171E−21 |
| A18 | 8.6153654828E−25 | 3.4852187355E−25 | 1.1319301414E−24 |
| A20 | −1.2011528525E−27 | −5.7770438841E−28 | −1.8662849379E−26 |

| Sn | 15 | 16 |
|---|---|---|
| KA | 1.0000000000E+00 | 1.0000000000E+00 |
| A4 | 1.6158007609E−06 | 1.1103698543E−05 |
| A6 | 1.7249994397E−08 | 1.3404604776E−08 |
| A8 | 1.2697856462E−12 | 4.3806760569E−11 |
| A10 | −1.0145016313E−13 | −1.3923488524E−13 |
| A12 | 7.6980281811E−16 | 7.4016856579E−17 |
| A14 | −9.1138966591E−19 | 2.2240070362E−18 |
| A16 | −3.4281048434E−21 | −3.4835878582E−21 |
| A18 | 1.1769482782E−23 | −1.6118651444E−23 |
| A20 | −2.8338709546E−27 | 4.8803969327E−26 |

The technique of the present disclosure has been described above using the embodiment and Examples. However, the technique of the present disclosure is not limited to the embodiment and Examples described above, and may be modified in various ways. For example, the curvature radius, the surface spacing, the refractive index, the Abbe number, the aspherical coefficient, and the like of each lens are not limited to the values shown in each example, and may take other values.

All documents, patent applications, and technical standards disclosed in this specification are incorporated in this specification by reference so that the incorporation of each of the documents, the patent applications, and the technical standards by reference is specific and is as detailed as that in a case where the documents, the patent applications, and the technical standards are described individually.

Further, the following supplementary notes will be further disclosed with regard to the embodiment described above.

### (Supplementary Note 1)

An optical system according to a first aspect including:
a first lens that is made of a resin having photocurability and a thermosetting property.

### (Supplementary Note 2)

The optical system according to the first aspect,
in which a coefficient of thermal expansion of the first lens is 6×10⁻⁵/° C.,
an elastic modulus of the first lens is 2.5×10⁹ Pa, and
a coefficient of thermal expansion of a second lens is 0.77×10⁻⁵/° C., and
an elastic modulus of the second lens is 106.7×10⁹ Pa.

### (Supplementary Note 3)

The optical system according to the first aspect,
in which a difference between a thickness of the first lens at a center of a convex surface and a thickness of the first lens at a first surface is 0.01 mm or more and 1 mm or less,
an effective diameter of the convex surface is 3 mm or more and 50 mm or less,
an outer diameter of the second lens is 4 mm or more and 110 mm or less,
a thickness of the second lens at a center of a concave surface is 0.5 mm or more and 10 mm or less,
an effective diameter of the concave surface is 3 mm or more and 50 mm or less, and
a curvature radius of the concave surface is 5 mm or more and 300 mm or less.

What is claimed is:

1. An optical system comprising:
a compound lens that includes a first lens and a second lens,
wherein the first lens is made of a resin,
the second lens is made of glass,
in a case where a maximum value of a thickness of the first lens is denoted by A [mm] and a minimum value of the thickness of the first lens is denoted by B [mm], Conditional Expressions (1) and (2), which are represented by A/B≤10 (1) and A≤3 mm (2), are satisfied, and
in a case where an amount of plastic deformation of the resin in a state where an indenter is pressed into the resin at a loading rate of 200 mN/10 sec at an environmental temperature of 25° C. is denoted by x [μm], the resin satisfies Conditional Expression (3) that is represented by 1.0 μm≤x≤4.0 μm (3).

2. The optical system according to claim 1,
wherein Conditional Expressions (5) and (6), which are represented by A≥0.1 mm (5) and B≥0.02 mm (6), are satisfied.

3. The optical system according to claim 1,
wherein a hardness of the resin at a temperature of 25° C. is 186 MPa or more and 196 MPa or less.

4. The optical system according to claim 1,
wherein a hardness of the resin at a temperature of 75° C. is 149 MPa or more and 164 MPa or less.

5. The optical system according to claim 1,
wherein an elastic recovery ratio of the resin at a temperature of 75° C. is 59% or more and 63% or less.

6. The optical system according to claim 1,
wherein an indentation elastic modulus of the resin at a temperature of 25° C. is 3.5 GPa or more and 3.6 GPa or less.

7. The optical system according to claim 1,
wherein an indentation elastic modulus of the resin at a temperature of 75° C. is 2.4 GPa or less.

8. The optical system according to claim 1,
wherein the resin has photocurability and a thermosetting property.

9. The optical system according to claim 1,
wherein the first lens is a lens that has a positive optical power and is made of the resin, and
in a case where a central thickness of the first lens is denoted by d, a curvature radius of a surface of the first lens facing an object side is denoted by Rf, and a curvature radius of a surface of the first lens facing an image side is denoted by Rr, Conditional Expression (7), which is represented by 0<d×(1/Rf−1/Rr)<0.05 (7), is satisfied.

10. The optical system according to claim 1, further comprising:
a front group;
an aperture stop; and
a rear group,
wherein the front group, the aperture stop, and the rear group are arranged in this order from an object side to an image side,
the rear group includes at least one Lp lens that has a positive optical power and is made of the resin,
the first lens is the Lp lens, and
in a case where a sum of a distance on an optical axis between a lens surface of the front group closest to the object side and a lens surface of the rear group closest to the image side and an air conversion distance on the optical axis between the lens surface of the rear group closest to the image side and an image plane in a state where the optical system is focused on an infinite distance object is denoted by TL and a focal length of the Lp lens is denoted by fp, Conditional Expression (8), which is represented by 0.1<TL/fp<1.2 (8), is satisfied.

11. The optical system according to claim 1, further comprising:
a front group;
an aperture stop; and
a rear group,
wherein the front group, the aperture stop, and the rear group are arranged in this order from an object side to an image side,
the rear group includes at least one Lp lens that has a positive optical power and is made of the resin,
the first lens is the Lp lens, and
in a case where a height of a principal ray, which has a maximum half angle of view, from an optical axis on a surface of the Lp lens facing the object side in a state where the optical system is focused on an infinite distance object is denoted by Hpp and a height of an axial marginal ray from the optical axis on the surface of the Lp lens facing the object side in a state where the optical system is focused on the infinite distance object is denoted by Hpm, Conditional Expression (9), which is represented by 0.2<Hpp/Hpm<1.1 (9), is satisfied.

12. The optical system according to claim 1, further comprising:
a front group;
an aperture stop; and
a rear group,
wherein the front group, the aperture stop, and the rear group are arranged in this order from an object side to an image side,
the rear group includes at least one Lp lens that has a positive optical power and is made of the resin,
the first lens is the Lp lens, and
in a case where a curvature radius of a surface of the Lp lens facing the image side is denoted by Rr, a distance on an optical axis between an image point, which is formed by an optical system ranging from a lens surface adjacent to an image side of the aperture stop to the surface of the Lp lens facing the image side, and the surface of the Lp lens facing the image side is denoted by De in a case where a point present at a position of the aperture stop on the optical axis is set as an object point in a state where the optical system is focused on an infinite distance object, De is calculated on an assumption that a medium closer to the image side than the surface of the Lp lens facing the image side is air, and a sign of De is set to be negative in a case where the image point is closer to the object side than the surface of the Lp lens facing the image side on the optical axis and is set to be positive in a case where the image point is closer to the image side than the surface of the Lp lens facing the image side, Conditional Expression (10), which is represented by −0.9<(De−Rr)/(De+Rr)<0.9 (10), is satisfied.

13. The optical system according to claim 1, further comprising:
a front group;
an aperture stop; and
a rear group,
wherein the front group, the aperture stop, and the rear group are arranged in this order from an object side to an image side,
the rear group includes at least one Lp lens that has a positive optical power and is made of the resin,
the first lens is the Lp lens, and
in a case where a focal length of a focus group moving along an optical axis during focusing is denoted by ffoc and a focal length of the Lp lens is denoted by fp, Conditional Expression (11), which is represented by 0.04<ffoc/fp<0.36 (11), is satisfied.

14. The optical system according to claim 1, further comprising:
a front group;
an aperture stop; and
a rear group,
wherein the front group, the aperture stop, and the rear group are arranged in this order from an object side to an image side,
the first lens is an Lp lens that has a positive optical power and is made of the resin, and
in a case where a maximum angle of view in a state where the optical system is focused on an infinite distance object is denoted by ωm, the rear group includes the Lp lens in a case where Conditional Expression (12), which is represented by ωm≥450 (12), is satisfied and the front group includes the Lp lens in a case where Conditional Expression (13), which is represented by ωm<450 (13), is satisfied.

15. The optical system according to claim 1, further comprising:
a front group;
an aperture stop; and
a rear group,
wherein the front group, the aperture stop, and the rear group are arranged in this order from an object side to an image side,
the rear group includes at least one Lp lens that has a positive optical power and is made of the resin,
the first lens is the Lp lens, and
in a case where a central thickness of the Lp lens is denoted by A, a thickness of the compound lens in an optical axis direction at a maximum effective diameter height on both surfaces of the Lp lens is denoted by B, a maximum image height is denoted by Y, a partial dispersion ratio of the Lp lens between a g line and an F line is denoted by θgF, an Abbe number of the Lp lens with respect to a d line is denoted by νd, and ΔθgF is represented by Conditional Expression (14) [ΔθgF=θgF−(0.6438−0.001682×νd) (14)], Conditional Expression (15), which is represented by 0.004<(|A−B|ΔθgF)/Y<0.020 (15), is satisfied.

16. The optical system according to claim 1, further comprising:
a front group;
an aperture stop; and
a rear group,
wherein the front group, the aperture stop, and the rear group are arranged in this order from an object side to an image side,
the compound lens is included in the front group, and
the second lens is disposed closer to the object side than the first lens.

17. The optical system according to claim 1, further comprising:
a front group;
an aperture stop; and
a rear group,
wherein the front group, the aperture stop, and the rear group are arranged in this order from an object side to an image side,
the compound lens is included in the rear group, and
the second lens is disposed closer to the image side than the first lens.

18. An optical system comprising:
a compound lens that includes a first lens and a second lens,
wherein the first lens includes a convex surface and a first surface that protrudes from an outer peripheral edge of the convex surface to an outside in a radial direction of the compound lens,
the second lens includes a concave surface that is cemented to the convex surface and a second surface that protrudes from an outer peripheral edge of the concave surface to the outside in the radial direction and is cemented to the first surface, and
in a case where a length of the first surface along the radial direction is denoted by a [μm], a length of the second surface along the radial direction is denoted by b [μm], and a surface roughness of the second surface is denoted by Ra [μm], Conditional Expressions (16) and (17), which are represented by a<b (16) and 5 μm≤a/Ra (17), are satisfied.
